(19) United States
(12) Patent Application Publication
(10) Pub. No.: US 2025/0201799 A1
(43) Pub. Date: Jun. 19, 2025

(54) METHOD AND APPARATUS FOR SYNTHESIZING TWO-DIMENSIONAL MATERIALS

(71) Applicant: Nicholas Huw Cartwright, Fakenham, Norfolk (GB)

(72) Inventor: Clive Stephen Delmonte, Fakenham, Norfolk (GB)

(21) Appl. No.: 18/852,288

(22) PCT Filed: Mar. 28, 2023
(86) PCT No.: PCT/EP2023/058002

§ 371 Date: Sep. 27, 2024

(30) Foreign Application Priority Data
Mar. 30, 2022 (GB) 2204585.0

(51) Int. Cl. H01M 4/04; H01G 11/26; H01G 11/48; H01G 11/86; H01M 4/60

(52) U.S. Cl. CPC H01M 4/0402; H01G 11/26; H01G 11/48; H01G 11/86; H01M 4/608

(57) ABSTRACT

A method of synthesizing a layer of two-dimensional material or a stack of layers of two-dimensional material comprises: providing (101) a liquid precursor composition on a flat surface of a liquid metal, the liquid metal being a metal or metal alloy having a melting point of less than or equal to 250° C. at a pressure of 1 atm; and forming (102) at least one layer of material on the surface of the liquid metal from the liquid precursor composition. By forming the layer or stack on the surface of the liquid metal, large layers and stacks which are free of wrinkles and creases may be obtained. Also provided are an apparatus useful for performing the method, and products such as energy storage devices obtainable by the method.

### BACKGROUND

In recent years, many two-dimensional (“2D”) substances have been used in a wide and rapidly growing range of industries including batteries; capacitors; computing; concrete; electronics, including flexible electronics; lubricants; medical diagnostics; quantum computing; “spintronics”; ropes; “twistronics”; and wearable textiles, including protective bodywear such as body armour.

A severe limitation upon the use of 2 dimensional products such as graphene has been the major difficulty of manufacturing large, high-quality specimens. Current technologies offer graphene specimens which are typically a maximum of around 1-3 cm². For example, graphene is made by Chemical Vapour Deposition (“CVD”) from a methane feedstock.

In the CVD process, the methane feedstock is heated to a molecular decomposition temperature of some 1200° C. The graphene precursor atoms must then cool down to ambient temperatures in vacuo on a solid substrate to form graphene. The solid substrate is a copper or nickel substrate with a specially-prepared crystalline face, such that a regular hexagonal pattern is imparted to the carbon atoms as they form molecules.

These conditions do not lend themselves to easy manufacture which would offer the cost benefit of economies of scale. Providing a large substrate with a suitable crystal face of adequate quality is extremely challenging.

Moreover, specimens produced by CVD are generally wrinkled, folded, creased or cracked. This is because the copper or nickel substrate contracts at a different rate to that of the product during the cooling, and has a different coefficient of contraction to that of the product.

Creases, wrinkles, cracks and folds negatively affect the product's properties, such as its electrical conductivity and mechanical strength. Obtaining a high purity product is also difficult, since unwanted impurities often fall onto the substrate. Furthermore, 3-dimensional (“3D”) fragments of fullerenes can form during the process, making it difficult to obtain a smooth 2D layer.

There remains a need in the art for methods and apparatuses for the synthesis of two-dimensional materials as large, high-quality specimens and on a large scale.

### SUMMARY

In one aspect, there is provided a method of synthesizing a layer of two-dimensional material or a stack of layers of two-dimensional material. The method comprises providing a liquid precursor composition on a flat surface of a liquid metal, the liquid metal being a metal or metal alloy having a melting point of less than or equal to 250° C. at a pressure of 1 atm; and forming at least one layer of two-dimensional material on the surface of the liquid metal from the liquid precursor composition. The use of a planar liquid metal surface as a substrate for preparing two-dimensional materials may offer various advantages. For example, large sheets of material may be prepared, and easy separation of the material from the substrate may be made possible.

A related, more general aspect provides a method of synthesizing a layer of a material or a stack of layers of material. The method comprises providing a liquid precursor composition on a flat surface of a liquid metal, the liquid metal being a metal or metal alloy having a melting point of less than or equal to 250° C. at a pressure of 1 atm; and forming at least one layer of material on the surface of the liquid metal from the liquid precursor composition. Many of the considerations applicable to the preparation of two-dimensional materials may be applicable also to the synthesis of other materials.

In another aspect, there is provided an apparatus for synthesizing a two-dimensional material. The apparatus comprises a bath for containing a liquid metal, a liquid metal being a metal or metal alloy having a melting point of less than or equal to 250° C. at a pressure of 1 atm; a movable barrier arranged in the bath and configured for compressing a horizontal film on a flat surface of the liquid metal; and a dipping device arranged over the bath. The apparatus is useful for performing the methods provided herein.

The dipping device of the apparatus comprises: a mounting for holding a rigid plate in an orientation in which a bottom edge of the rigid plate faces a base of the bath; an actuator for lowering the rigid plate into the bath and for raising the rigid plate from the bath; and an actuator for changing a yaw of the rigid plate. The dipping device may allow easy removal of the product from the surface of the liquid metal, and may be useful in the synthesis of “magic angle” stacks, as will be explained in more detail later.

Still another aspect provides an energy storage device. The energy storage device comprises an anode; a cathode; and a dielectric arranged between the anode and the cathode. One or more of the anode, the cathode, and the dielectric comprises a layer of two-dimensional material or stack of layers of two-dimensional material. The two-dimensional material may be obtainable by a method as provided herein.

The energy storage device may be a battery or capacitor. The device may be an “all polymer” device, free of metal atoms or metal ions. This may offer environmental benefits, since extraction of e.g. lithium for use in conventional lithium-ion batteries has a significant environmental impact.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a flow diagram outlining an example method of synthesizing a layer or stack of layers of two-dimensional material;

FIG. 2 is a flow diagram outlining an example method of synthesizing a stack of layers of two-dimensional material;

FIG. 3 is a block diagram of an example system useful for implementing the methods;

FIG. 4 is a front view of an example dipping device which may be included in the system;

FIG. 5 is a perspective view of an example suction device which may be included in the system;

FIG. 6 is a structural diagram of a fragment of graphene from an infinite single 2D sheet;

FIG. 7 is a structural diagram of a fragment of an infinite 2D sheet of an N-doped analogue of porous graphene referred to herein as “planar porous quinoxaline-graphene”;

FIG. 8 is a schematic cross-section of an example energy storage device;

FIG. 9 is a diagram showing a view of the front face of paranemic B Form DNA with Watson-Crick Base Pairing (reproduced with permission from Dr Ken Biegeleisen);

FIG. 10 is a diagram of paranemic Z Form DNA with Hoogsteen Base Pairing (reproduced with permission from Dr Ken Biegeleisen); and

FIG. 11 is a schematic cross-section of an example composite cable.

### DETAILED DESCRIPTION

The verb ‘to comprise’ is used herein as shorthand for ‘to include or to consist of’. In other words, although the verb ‘to comprise’ is intended to be an open term, the replacement of this term with the closed term ‘to consist of’ is explicitly contemplated, particularly where used in connection with chemical compositions.

Directional terms such as “top”, “bottom”, “up”, “down”, “left”, “right”, “above”, “below”, “horizontal” and “vertical” are used herein for convenience of description and relate to the orientation shown in the relevant drawing. For the avoidance of any doubt, this terminology is not intended to limit orientation in an external frame of reference.

It will be appreciated that some compounds referred to herein may be ionisable, i.e., may be weak acids, weak bases, or ampholytes. Ionisable compounds may be present in their free forms, ionised forms, or as salts.

All melting points and boiling points reported herein are measured at atmospheric pressure (1 atm; about 101 kPa), unless otherwise stated.

All percentages are by weight based on the total weight of the relevant composition, unless otherwise explicitly stated.

A “low” temperature is a temperature of less than or equal to 250° C.

A “two-dimensional material”, also referred to as a “two-dimensional substance” or “single-layer material”, is a crystalline material with a thickness of one monolayer.

A “stack” is a laminate structure comprising two or more layers of two-dimensional material. A “composite substance” is a stack which includes layers of at least two different two-dimensional materials.

A “liquid metal” is a metal, mixture of metals, metal alloy, or amalgam which has a melting point of less than or equal to 250° C. When in use, the liquid metal is in a liquid phase.

As used herein, the “surface of the liquid metal” refers in particular to the interface between the liquid metal and another phase, for example a liquid composition comprising precursors for forming a two-dimensional material. The “surface” may also encompass the upper part of the liquid metal, down to a depth of 20 atoms from the interface; and/or any layers of product present on the liquid metal.

“OEEF” stands for “oriented external electric field”.

If not otherwise stated, the term “alkyl group” may refer in particular to a C₁ to C₃ alkyl group. Longer-chain alkyl groups may be present in some implementations.

Provided herein are methods for synthesising two-dimensional materials and stacks of two-dimensional materials on a liquid metal substrate. The use of the liquid metal substrate may allow for the synthesis of arbitrarily large sheets of material. The use of the liquid metal substrate may also allow the two-dimensional material to be removed easily from the substrate, without introducing wrinkles, folds, or cracks. This is because the two-dimensional material typically floats on the liquid metal substrate.

The methods may be used to synthesise a wide variety of two-dimensional materials, as well as stacks and composites based on two-dimensional materials.

In one example, the present disclosure provides a composite useful as an all-polymer energy storage device.

Also provided is an example apparatus useful for practising the methods.

### Methods

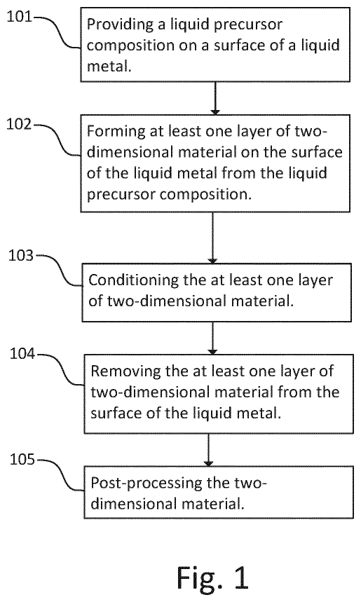

An example method of synthesising a 2-dimensional material will now be described with reference to FIG. 1. FIG. 1 is a flow diagram outlining the method.

At block 101, a liquid precursor composition is provided on a surface of a liquid metal.

A liquid precursor composition comprises one or more reagents which will be used to synthesise the 2-dimensional material. The reagents may be selected as appropriate depending upon the nature of the 2-dimensional material to be synthesised. Various illustrative examples will be provided further below.

The liquid precursor composition may be a solution of the one or more reagents. Liquid metals are immiscible with many common solvents. Furthermore, liquid metals have a very high density. The nature of the solvent is therefore not particularly limited. Illustrative examples include water; organic solvents such as alcohols, toluene, and xylene; and co-solvent mixtures comprising water and one or more organic solvents.

The liquid precursor composition may comprise a pure liquid, a mixture of liquids, a solution, or an emulsion.

The liquid precursor composition is preferably free of solid particulates. This may allow more reliable delivery of the liquid precursor composition to the surface of the liquid metal substrate, since particulates can clog liquid delivery devices such as spray heads.

More than one liquid precursor composition may be present. For example, two immiscible liquid phases may be provided on the surface of the liquid metal.

Typically, the liquid precursor composition is provided as a thin layer. Performing the synthesis using a thin layer of precursor composition may constrain growth of the product to two dimensions. The term “thin layer” refers in particular to a layer having a thickness in the range 1 to 10 monolayers, though layer thicknesses outside this range may be used provided that growth of the product is constrained to two dimensions.

The surface area of the thin layer is not particularly limited and may be selected as appropriate. Liquid metal surfaces of any arbitrary size may be prepared. The present method may be used to produce ultra-large sheets, an ultra-large sheet being a sheet having an area of greater than or equal to 0.5 m².

The liquid metal has a planar, in other words flat or horizontal, surface. The planar surface of the liquid metal may have a surface area of at least 5 cm². There is no particular upper limit on the size of the planar surface.

A mask may be arranged on the surface of the liquid metal, and the thin layer may be formed in an opening in the mask. The mask may shield the meniscus between the liquid metal and the sides of its container. The mask may be used to control the shape of the two-dimensional material.

A thin layer may be formed by applying, for example spraying, a measured amount of liquid precursor composition onto the surface of the liquid metal, optionally in combination with the use of a movable barrier to compress the liquid precursor composition into a smaller surface area. The formation of a monolayer may be detected based on an increase in resistance to movement of the barrier, or by Raman spectroscopy, for example.

The liquid precursor composition may include a wetting agent. The wetting agent may allow a thin layer of the liquid precursor composition to be obtained more easily. The wetting agent if present may be selected as appropriate depending upon the nature of the liquid composition and the nature of the liquid metal.

Sonication may be used to form the thin layer. Sonication may be useful for spreading the precursor composition over the surface of the liquid metal, for example, by breaking up droplets.

The liquid metal is in a liquid state throughout the synthesis of the 2-dimensional material. The liquid metal typically has a bulk temperature in the range between its melting point and 250° C. The nature of the liquid metal is not particularly limited. Various examples of suitable liquid metals will be provided further below.

Subsequently, at block 102, at least one layer of two-dimensional material is formed on the surface of the liquid metal. A single layer of 2-dimensional material may be formed, or a stack of two or more such layers arranged one atop the other may be formed. Block 102 may comprise performing a chemical reaction and/or inducing a physical change.

A broad range of reactions may be performed in a thin layer on a surface of a liquid metal. The use of many different techniques is possible.

Illustrative examples of reactions which may be performed on the surface of a liquid metal include electrochemical processes such as anodic decarboxylation and electrolytic deposition. The electrolytic deposition may in particular be from one or more aprotic solvents.

Other examples of reactions include aldehyde benzoin condensation; the polymerization of alkynes and graphdiynes; and thermal decompositions, such as the dehydration of metal ammines. Still another example reaction is the Stephen conversion of nitriles to aldehydes. Various detailed worked examples are provided further below.

Reactions which do not form solid by-products are preferred. Gaseous by-products may be captured, for example by a fume cupboard cooling system. Liquid by-products may be removed, by evaporation, suction, or washing, for example.

Performing the reaction may comprise adding one or more additional reagents to the thin layer of liquid precursor composition. The one or more additional reagents may be in a liquid phase, for example applied by spraying. Alternatively or additionally, the one or more additional reagents may be supplied from a gaseous phase.

Liquid metals are stable with respect to heat, electricity, and electromagnetic radiation. A liquid metal will typically have a higher density than the product, and will generally not dissolve the product. Therefore, the product can be expected to float and to be easily recoverable. These properties may allow for the use of a wide variety of different techniques.

Performing the reaction may include heating the liquid precursor composition. One example of a reaction which makes use of heating is the formation of 2D boron nitride from a mixture comprising ammonium chloride and an adduct of dimethyl sulfide with boron trichloride.

The heating may be surface heating, optionally flash heating. For example, a heater such as an infrared lamp arranged above the liquid metal may be used. Liquid metals have good thermal conductivity and may act as heat sinks. When surface heating is used, the surface temperature of the liquid metal may be higher than its bulk temperature, and may temporarily exceed 250° C.

Other techniques for surface heating include the use of hot air or steam.

Alternatively or additionally, the liquid metal may be heated and used to supply the heat to the liquid precursor composition.

The reaction may comprise passing an electric current through the liquid precursor composition.

The reaction may comprise passing a current through the thin layer of liquid precursor composition. Passing a current through the thin film of liquid precursor composition allows for a variety of electrochemical processes to be performed. One useful example is electrolytic condensation, also referred to as anodic synthesis. One example of an anodic synthesis is anodic decarboxylation.

In one example of anodic synthesis, cyclohexane-1,3,5-tricarboxylic acid is provided on a surface of the liquid metal. The cyclohexane-1,3,5-tricarboxylic acid may be in the form of a salt, such as a potassium salt. A positive voltage is applied to the resulting layer. This results in an anodic decarboxylation of the cyclohexane-1,3,5-tricarboxylic acid, resulting in the formation of graphene.

In contrast to water, which typically begins to electrolysis once the applied voltage exceeds about +2 V, the voltage which may be applied to a liquid metal is not particularly limited. An appropriate voltage for performing a desired electrochemical reaction may be determined by increasing the voltage until deposition of the product starts. As will be appreciated, the precise voltage to be used for a particular reaction may vary depending upon temperature, the composition of the liquid metal, and the number of layers of the product already deposited, amongst other factors.

Usefully, the liquid metal may act as an electrical ground. This may allow electrochemical processes to be performed using only a single electrode.

A still further possibility is to make use of electromagnetic radiation to cause a reaction in the thin layer of liquid precursor. For example, ultraviolet light may be used to initiate radical polymerisation and/or to cross-link polymer chains. Alternatively, X-rays may be used to initiate reactions.

It may be desirable to align molecules before or during the reaction, in particular where the reaction comprises cross-linking of polymer chains. In some implementations, an oriented external electric field, OEEF, may be applied to cause alignment of reagents. Alternatively or additionally, advantage may be taken of a flowing liquid metal substrate. The liquid metal may be caused to flow using, for example, a recirculating pump.

Forming the two-dimensional material may comprise inducing a physical change. For example, forming the two-dimensional material may comprise deposition of the material from an aprotic solvent. Liquid metals are stable with respect to heat, electricity, and electromagnetic radiation. A liquid metal will typically have a higher density than the product, and will generally not dissolve the product. Therefore, the product can be expected to float and to be easily recoverable as remarked earlier.

The formation of the two-dimensional material is typically performed at a pressure of 1±0.5 atm, optionally 1±0.8 atm, further optionally at about 1 atm. Although the pressure to be used is not particularly limited, working at or close to ambient pressure is often preferred. The reaction may be performed in an inert gas atmosphere, e.g., under argon, if desired.

Horizontal compression may be applied to the thin layer during formation of the two-dimensional material. Horizontal compression may increase the size of grains and reduces grain boundaries which may improve quality of the product. As well as modifying the reaction conditions, horizontal compression may allow for detection of the formation of two-dimensional materials. The resistance of the thin layer to compression may change when the product forms.

Sonication may be applied during the formation. Sonication may break up protrusions and structural irregularities in the product. Sonication may help to spread the liquid precursor composition over the surface of the liquid metal substrate, e.g. by dispersing any surface droplets.

Another useful technique for monitoring progress of reactions in thin films is Raman spectroscopy.

A series of reactions may be performed. For example, one or more intermediate products may be formed in situ on the liquid metal, which may subsequently undergo further reactions to form the two-dimensional material.

Optionally, reactions of the two-dimensional material may be performed in situ on the surface liquid metal after block 102. One example is the in situ oxidation of graphene to form graphene oxide.

After forming the layer of 2-dimensional material, the 2-dimensional material is optionally conditioned on the surface of the liquid metal, at block 103. By conditioning is meant relieving internal strain and stress within the product.

Useful techniques for conditioning the product include compression, sonication, and annealing. Any combination of these techniques may be used if desired.

Annealing may be performed in situ on the surface of the liquid metal. Annealing typically comprises heating the two-dimensional material to a temperature of about 80% of its melting point. The use of laser annealing is also contemplated.

Since the product lies on a liquid metal surface, it is only the surface which needs to reach the annealing temperature. The underlying liquid metal may serve as a heat sink, removing the surface heat. High local high annealing temperatures may thus be used without overheating the whole mass of liquid metal and the 2D product. Overheating of the apparatus itself may also be avoided.

Annealing temperatures of some example materials are set out in Table 1.

TABLE 1
Melting points and suggested annealing temperatures for selected materials.

| Element | Melting point/° C. | Annealing temperature/° C. |
|---|---|---|
| In | 157 | 126 |
| Tl | 304 | 243 |
| Sn | 232 | 186 |
| Pb | 327 | 262 |
| P | 44 | 35 |
| As | 302 | 242 |
| Bi | 271 | 217 |
| S | 113 | 90 |
| Se | 217 | 174 |
| Te | 449 | 360 |
| Zn | 420 | 336 |

Following any optional conditioning, the two-dimensional material is removed from the surface of the liquid metal at block 104.

Two-dimensional materials are chemically contiguous. As such, a two-dimensional material is distinct from a Langmuir-Blodgett film, which comprises discrete molecules forced together by compression and bound only by weak physical bonds (e.g., van der Waals forces or hydrogen bonding). The chemically-contiguous nature of two-dimensional materials allows such materials to be drawn off the surface without disruption of their structure. In contrast, removing a Langmuir-Blodgett film from its supporting surface is believed to be impossible to accomplish.

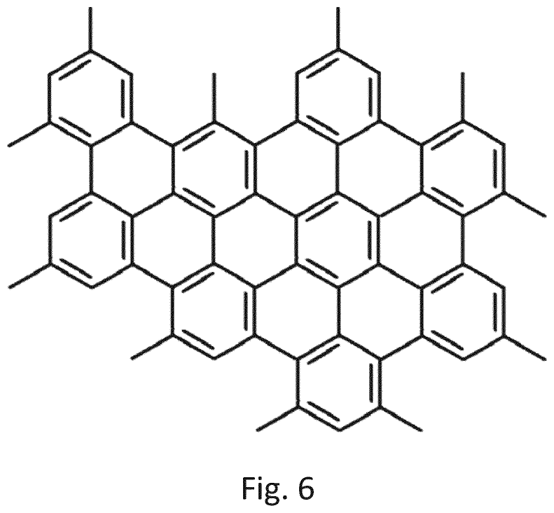

For example, a suction device such as device 500 of FIG. 5 may be used to remove the two-dimensional material from the surface.

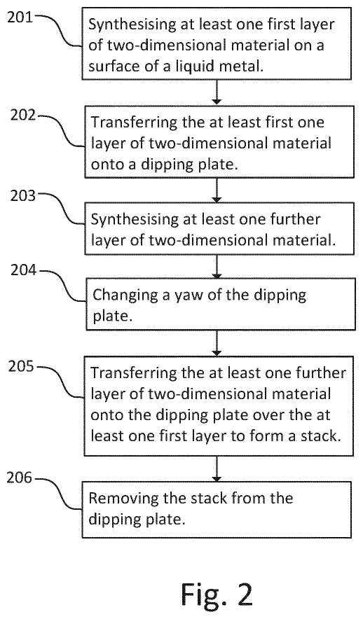

Alternatively, the product may be transferred onto a dipping plate additionally using horizontal surface compression of the product, as described below with reference to block 202 of FIG. 2. The product may be subsequently removed from the dipping plate as described with reference to block 206 of FIG. 2.

Another example technique for removing a two-dimensional material from the surface of the liquid metal is to form a carrier film over the two-dimensional material to allow for easier handling. An example carrier film is poly(methyl methacrylate). The carrier film may then be separated from the two-dimensional material. For example, poly(methyl methacrylate) may be removed using acetone.

These techniques may allow for recovery of a high quality 2D solid product. Compared to processes which use solid substrates, such as CVD, the amount of cracking, wrinkling and the like introduced when recovering the product may be substantially reduced. The present methods may allow sheets of 2D materials of arbitrary size to be obtained, since the 2D material floats on the liquid metal substrate without binding strongly to the surface of the substrate.

A still further possibility is to solidify the liquid metal before removing the product. This approach may be useful if templating solids onto the product is desired, and especially in the construction of solar panels.

After removing the two-dimensional material from the surface of the liquid metal, the material is optionally post-processed at block 105.

Post-processing may comprise, for example, winding the material into a thread. The thread may be a one-dimensional material. A one-dimensional material has a small and substantially constant breadth and width, and length which is larger than the breadth and width (e.g., by a factor of at least 1,000). In particular, the manufacture of graphene threads is contemplated.

The preparation of a thread may be implemented as a continuous process, in which 2D material is formed continuously and drawn from the surface at an equivalent rate.

Articles may be woven from the thread. The thread may be used to form a string. Threads and strings formed of two-dimensional materials may be optically transparent, strong, and may have high refractive indices. Such threads and strings may be useful as components of fibre-optic cables. Alternatively, threads and strings may be useful for optical computing.

The thread may be single-stranded or multi-stranded. A single-stranded thread may be referred to as a wire.

The thread may be used to form a rope. Ropes of two-dimensional materials may be strong and may be good electrical conductors. Such ropes may be useful in electrical power grids or electrical power distribution systems.

In implementations where the 2D material is optically-transmissive, threads may be used in devices which rely on the transmissibility of electromagnetic radiation such as fibre optics and optical computing devices. For example, graphene is optically transmissive and has a high refractive index, which may allow for improved containment of optical signals.

In implementations where the 2D material is electrically conductive, threads may be used to conduct electricity and generate magnetic fields. Threads may be used in motors, especially reluctance motors; dynamos; and electronic devices. Graphene is an example of an electrically-conductive 2D material.

2D materials such as graphene may be less dense than copper, and may have higher conductivity. Threads of 2D materials may therefore be particularly useful as electrical conductors for aerospace applications (e.g., in aeroplanes, drones, missiles, rockets, and space vehicles), and other applications in which low weight is important.

2D materials such as graphene may be stronger than steel, and may be a better conductor than both steel and copper. 2D materials may therefore be useful for energy and power distribution.

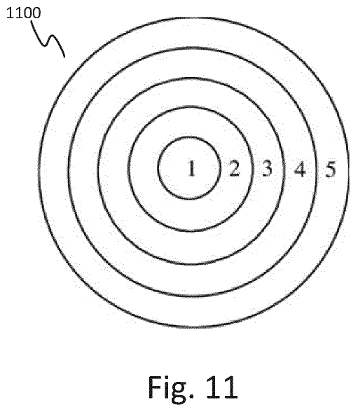

Two or more of these properties may be exploited simultaneously by providing a multi-core cable such as that described below with reference to FIG. 11.

Post-processing may comprise applying the two-dimensional material to a surface of an object. Notable examples of objects which may be coated with two-dimensional material include photovoltaic cells and wind turbine blades.

A photovoltaic cell may be constructed based on the 2-dimensional materials provided herein. The methods provided herein may allow composite 2-dimensional materials or arbitrary size to be obtained. Such materials may be flexible, and may therefore be shaped to fit a support. By way of illustration, a photovoltaic cell may be integrated into a land vehicle (e.g., a bus, lorry, train), and more specifically the roof of a land vehicle; a watercraft (e.g., the sail of a yacht); a building; or a structure such as a wind turbine blade.

Post-processing may comprise assembling an electronic component, in particular an energy storage component, comprising the two-dimensional material.

Various modifications may be made to the method of FIG. 1.

Blocks 103 and 104 are optional, and one or both of these blocks may be omitted.

Although FIG. 1 has been described in the context of synthesising a layer of two-dimensional materials, the method may equally be used to synthesise stacks comprising a plurality of such layers, by iterating the operations of blocks 101 and 102. The two-dimensional materials in the stack may be same or different. A stack comprising two or more different materials is referred to herein as a “composite”.

One variant of the method of FIG. 1 will now be described with reference to FIG. 2. FIG. 2 is a flow diagram outlining a method useful for forming stacks or composites comprising a plurality of layers of 2-dimensional material.

At block 201, at least one first layer of 2-dimensional material is synthesised on a surface of a liquid metal. This synthesis may be as previously described with reference to blocks 101 and 102, and optionally 103, of FIG. 1.

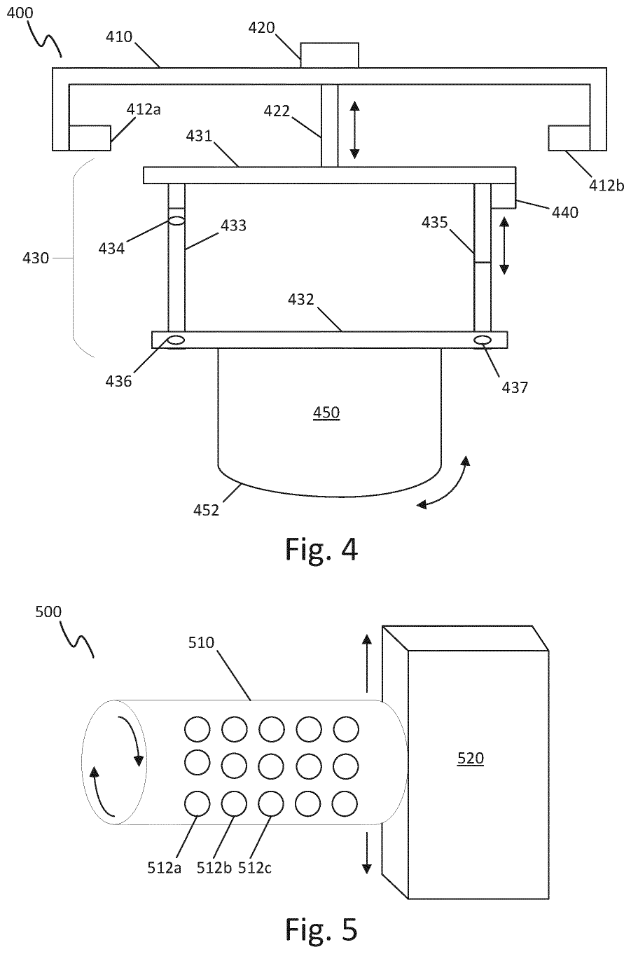

At block 202, the at least one first layer of 2-dimensional material is transferred onto a dipping plate. The dipping plate may be a dipping plate of dipping device 400 as described later with reference to FIG. 4.

Transferring the at least one first layer of 2-dimensional material onto the dipping plate may comprise lowering the dipping plate edgewise into the liquid metal. The 2-dimensional material adheres to the major surface of the dipping plate. The 2-dimensional material may adhere to both sides of the dipping plate. The dipping plate may be sized such that the entirety of the at least one first layer of 2-dimensional material may be transferred onto the dipping plate by lowering the dipping plate edgewise into the liquid metal.

Alternatively, the synthesis of block 201 may be performed with the dipping plate submerged in the liquid metal. The dipping plate may be raised from the liquid metal to transfer the 2-dimensional material from the liquid metal.

Starting with the dipping plate above the liquid metal may be preferred if a stack comprising an even number of layers is to be prepared. Starting with the dipping plate submerged in the liquid metal may be preferred if a stack comprising an odd number of layers is to be prepared.

Subsequently, at block 203, at least one further layer of 2-dimensional material is synthesised on the surface of the liquid metal. The synthesis may be as described with reference to blocks 101 to 103 of FIG. 1. The 2-dimensional material may be the same as or different from the 2-dimensional material synthesised at block 201.

The synthesis performed at block 203 may be performed while the dipping plate is submerged in the liquid metal, with the at least one first layer of two-dimensional material remaining on the dipping plate. Alternatively, the dipping plate may be withdrawn from the liquid metal before block 203.

FIG. 2 includes optional block 204, in which the yaw of the dipping plate is changed. Changing the yaw means rotating the dipping plate in a direction in the plane of the major surface of the dipping plate. The rotation is typically by less than about 10°. When block 204 is included, the method may be referred to as a “magic angle” process.

Stacks of 2-dimensional materials may display different properties depending upon the relative orientations of layers in the stack. For example, graphene bilayers, formed with horizontal surface compression, have been reported to have special electrical properties when the two layers are angled by 0.79, 1.10, 1.59, 2.02, or 3.48° with respect to one another.

In graphene trilayers, the third layer may be rotated (angled) with respect to the second layer by an angle of V2 times the angle between the first two layers. Graphene trilayers display a further series of changed electrical properties.

Rotating the dipping plate, and thus rotating the 2-dimensional material which is present on the dipping plate, allows for the production of large-area stacks with differently oriented layers.

Subsequently, at block 205, the at least one further layer of 2-dimensional material is transferred onto the dipping plate over the at least one first layer, thereby forming a stack. The transferring process may be performed as previously described with reference to block 202.

Blocks 203 to 205 may be repeated as desired to form stacks with larger numbers of layers.

Once the desired stack has been prepared, the stack is removed from the dipping plate at block 206.

The dipping plate may comprise two sheets of a rigid, dissolvable material sandwiched together. In such implementations, the 2D material is transferred onto the outer surface of the sandwiched sheets. Examples of rigid, dissolvable materials include polycarbonate and poly(methyl methacrylate).

Two-dimensional material may be transferred onto both sides of the dipping plate.

The dipping plate may be removed from the dipping device. The two sheets may be folded apart from one another, with the two-dimensional material serving as a hinge.

The opened dipping plate may then be placed in a solvent bath to contact the rigid, dissolvable material with an appropriate solvent for dissolving the dissolvable material. Typically, the dipping plate is placed with the two-dimensional material facing upwards and is tethered by at least one edge.

The solvent bath dissolves away the dipping plate, freeing the two-dimensional material. This may allow for the recovery of larger sheets of two-dimensional material, and may effectively double the size of the sheets which can be recovered.

The solvent may be selected as appropriate depending upon the nature of the rigid, dissolvable material. An example of a suitable solvent for polycarbonate is dichloromethane. An example of a suitable solvent for poly(methyl methacrylate) is acetone.

Various modifications may be made to the method of FIG. 2. For example, the operations of block 204 may be performed before those of block 203. Block 204 may be omitted from some implementations.

As an alternative to the dipping method described with reference to block 202, Langmuir-Schaefer dipping may be used. Langmuir-Schaefer dipping transfers material onto one side of a dipping plate.

Removal of 2-dimensional materials or stacks from liquid metal surfaces may include cutting the material or stack. For example, 2-dimensional materials and stacks may be cut using a polytetrafluoroethylene, PTFE, rod.

The method may further comprise, after removing the 2-dimensional material from the liquid metal substrate, winding the 2-dimensional material into a wire or thread.

If desired, synthesis of stacks and composites may be performed without transferring materials onto a dipping plate.

Since the 2-dimensional material typically does not adhere to the liquid metal substrate, removal of the 2-dimensional material from the substrate may be achieved without applying horizontal pressure.

### Systems and Apparatuses

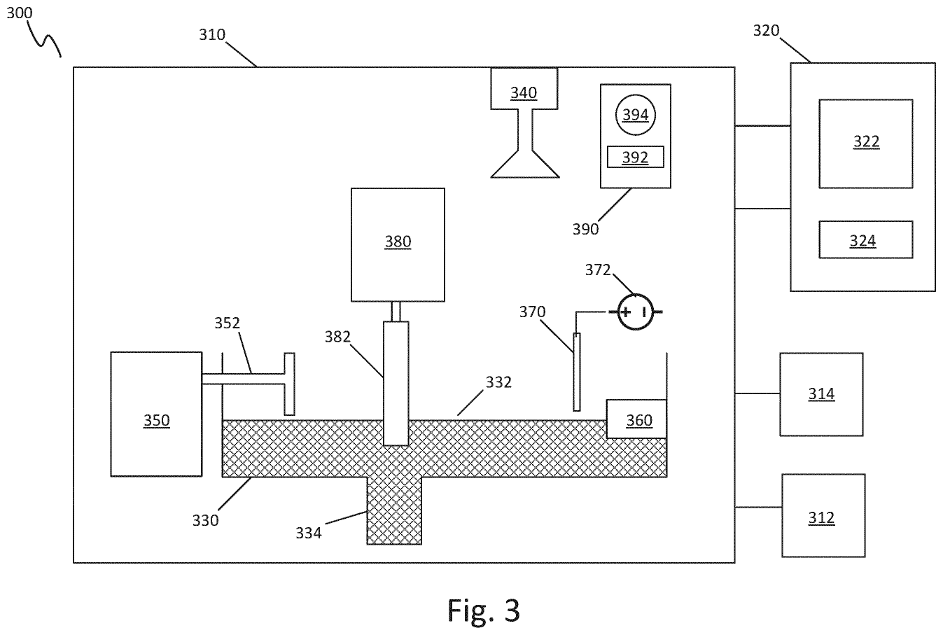

An example system useful for synthesizing a layer of two-dimensional material or a stack of such layers will now be described with reference to FIG. 3. FIG. 3 is a schematic block diagram of the system.

The system 300 includes an apparatus and a control module 320.

The control module 320 includes a processing apparatus 322 which is operably linked to data storage 324. The control module 320 may optionally be operably linked to a user terminal. The data storage 324 stores a computer program for execution by the processing apparatus 322. Execution of the computer program by the processing apparatus 322 causes the system to perform one or more steps of a method as described herein.

The user terminal may include user input equipment and a display device. The user input equipment may comprise any one or more suitable input devices known in the art for receiving inputs from a user. User input equipment may be useful for allowing a user to select operating parameters for the system. User input equipment may be omitted when operating parameters are determined in some other way, for example, programmatically or in response to a message received over a network.

The display device may take any suitable form for outputting images, such as a light emitting diode (LED) screen, liquid crystal display (LCD), plasma screen, or cathode ray tube (CRT). A display device is useful in implementations where it is desired to display human readable output to a user.

The processing apparatus 322 includes one or more processing units implemented in one or more dies, IC (integrated circuit) packages and/or housings at one or more geographic sites. Each of the one or more processing units may take any suitable form known in the art, e.g. a general-purpose central processing unit (CPU), or a dedicated form of co-processor or accelerator processor such as a graphics processing unit (GPU), digital signal processor (DSP), etc. Each of the one or more processing units may comprise one or more cores. The processing apparatus 322 typically further comprises working memory, such as random-access memory and/or one or more memory caches within the one or more processing units. Where it is said that a computer program is executed on the processing apparatus, this may mean execution by any one or more processing units making up the processing apparatus 322.

The data storage 324 comprises one or more memory units implemented in one or more memory media in one or more housings at one or more geographic sites. Each of the one or more memory units may employ any suitable storage medium known in the art, e.g. a magnetic storage medium such as a hard disk drive, magnetic tape drive etc.; or an electronic storage medium such as a solid-state drive (SSD), flash memory or electrically erasable programmable read-only memory (EEPROM), etc.; or an optical storage medium such as an optical disk drive, etc. Where it is said herein that some item of data is stored in data storage 324 or a region thereof, this may mean stored in any part of any one or more memory devices making up the data storage 324.

The processing apparatus 322 and data storage 324 are operably linked. The processing apparatus and data storage are configured such that processing apparatus 322 is capable of reading data from at least a portion of data storage 324, and writing data to at least a portion of the data storage 324. The processing apparatus 322 may communicate with the data storage 220 over a local connection, e.g. a physical data bus and/or via a network such as a local area network or the Internet. In the latter case the network connections may be wired or wireless.

The system includes an enclosure 310, a bath 330, a dispensing device 340, a barrier device 350, an ultrasound generator 360, an electrode 370 and voltage source 372, a dipping device 380, and a monitoring device 390.

In this example, enclosure 310 is in the form of a sealed chamber. The enclosure 310 allows for control over the environment in which the synthesis will be performed. For example, it may be desirable to perform certain reactions in an inert gas atmosphere. A sealed chamber may also be useful implementations where gas phase reagents are used.

The enclosure 310 of this example is coupled to a gas extraction system 312 for removing gas from the chamber and a gas supply 314 for introducing gas into the chamber.

The gas extraction system 312 may be useful for controlling pressure in the chamber, for capturing metal vapour, for capturing solvent vapours, and/or for extracting gaseous by-products.

The gas extraction system may be configured to allow for the recovery of chemicals. The gas extraction system 312 may be configured to capture metal vapours, such as mercury vapour. The gas extraction system 312 may be configured to capture organic vapours, such as toluene and/or xylene. The gas extraction system 312 may be configured to capture by-products or side products of the reactions described herein. For example, certain syntheses described herein may release iodine vapour. Chemicals captured by the gas extraction system may be recycled.

The inclusion of a gas extraction system is particularly preferred in implementations where the liquid metal comprises mercury, since mercury vapour may be hazardous.

Performing reactions at pressures of less than 1 atm may be desirable where the reaction involves the use of VUV radiation. Lowered pressure may raise the efficacy of VUV radiation.

The gas supply may be useful for controlling pressure in the chamber and/or for supplying gaseous reagents to the chamber. For example, it may be desirable in some implementations to pass a gas such as oxygen, ozone, nitrogen, or nitrogen dioxide over the liquid metal surface and any substance on that surface.

The enclosure may include heating and/or cooling devices and a thermostat for controlling the temperature within the chamber.

The enclosure may include mounting points or fixings for holding other components of the system.

The use of a sealed chamber is optional. For example, the bath 330 may instead be arranged in a fume hood. The enclosure 310 may be omitted entirely in other implementations, where volatility of the liquid metal is not a concern.

The system includes a bath 330 for holding a liquid metal 332. The bath 330 may also be referred to as a trough, tray, or dish. The bath 330 has a base and side walls. The bath 330 typically stands on a shock-proof and vibration-proof surface or support, and desirably remains horizontal when in use. For example, the bath may be mounted on a vibration reduction system.

The configuration of the bath 330 is not particularly limited. The bath 330 may be formed from any suitable material, for example steel, optionally stainless steel. In implementations where the liquid metal will include mercury or gallium, the bath 330 preferably does not comprise aluminium, since mercury and gallium can corrode aluminium.

Liquid metals have high density. The bath and any supporting structures may include mechanical reinforcement to support the weight of the liquid metal. The external surface of the bath may be provided with thermal and/or electrical insulation. The inclusion of electrical insulation is preferred in implementations where the system includes one or more electrodes for performing electrochemical reactions.

The bath 330 may have any appropriate shape. For example, the bath 330 may be generally rectangular or generally circular in plan. The surface area of the bath is not particularly limited, and may be selected as appropriate depending upon the size of the two-dimensional material to be synthesized. By way of illustration, the bath 330 may have a surface area in the range 0.5 m² to 5 m² or higher.

In the present example, bath 330 includes a well or channel 334. The well or channel 334 is a region of the bath which has an increased depth, for receiving a dipping plate 382 mounted on dipping device 380. The well or channel 334 may be slit-shaped.

The depth of the well or channel 334, the surface area of the bath 330, and the dimensions of the dipping plate 382 may be selected such that the entirety of a layer of 2D material formed on the surface of liquid metal in the bath 330 may be transferred onto the dipping plate 382 by lowering dipping plate 382 into well or channel 334, optionally in the absence of horizontal compression of the layer of 2D material.

When in use, the bath is at least partially filled with liquid metal. The quantity of liquid metal is selected to cover the base of the bath. Since reactions are performed at the surface of the liquid metal, the depth of the liquid metal is not particularly limited provided that the base of the bath is covered by a contiguous layer of liquid metal. By way of illustration, bath 330 may have side walls having a height in the range 5 to 10 cm, optionally 5 cm. The bath may be filled with liquid metal such that the depth of the liquid metal in the relatively shallow regions away from channel 334 is typically in the range 1 to 2 cm.

The system further comprises a dispensing device 340 arranged above the bath 330. The dispensing device 340 may comprise, for example, one or more spray heads fed by one or more peristaltic pumps. The dispensing device may allow an even distribution of small droplets, or mist, of liquid precursor composition to be supplied to the surface of the liquid metal. The dispensing device may be configured to dispense a wetting agent.

The spray heads may be configured to deliver liquid precursor to the entire surface of the liquid metal.

The spray heads may be mobile. This may allow a small number of spray heads to deliver compositions to the entire surface of the liquid metal. The spray heads may be manually movable by an operator. Alternatively, the spray heads may be movable by a motor controlled by control unit 320.

The dispensing device allows for liquids comprising reagents and/or wetting agents to be dispensed onto the surface of the liquid metal 332. In this example, a single dispensing device 340 is illustrated, but it will be appreciated that a plurality of dispensing devices may be included, for example to allow different reagents to be dispensed.

The system further comprises a barrier device 350 including a movable barrier 352 and a mechanism for moving the movable barrier. The movable barrier 352 typically extends across the whole width of the bath. The barrier device 350 may be useful for forming and/or compressing monolayers on the surface of the liquid metal 332. The barrier device may be configured to detect formation of a monolayer. Monolayer formation may cause an increase in resistance to the motion of the barrier 352.

Suitable barrier devices include those of the type used to form monolayers on aqueous media in Langmuir-Blodgett troughs.

An ultrasound generator 360 is arranged in the bath 330. Ultrasound generator 360 is useful for applying ultrasonic waves to a layer on the surface of the liquid metal 332.

The system may further comprise ultrasonic detectors. Ultrasonic detectors may be useful for, for example, detecting formation of a thin layer of liquid or the formation of a two-dimensional material.

The barrier device 350 and ultrasound generator 360 may be useful individually or in combination at many stages of the methods described herein. Ultrasound and/or compression using the barrier may be useful when forming a thin layer of liquid precursor composition on the surface of the liquid metal; during reactions performed on the surface; and/or in the conditioning of two-dimensional materials, e.g. during annealing processes.

System 300 further comprises an electrode 370, electrically connected to a voltage source 372. The electrode and voltage source are useful for passing an electric current through a thin layer of liquid precursor composition on the surface of the liquid metal 332. This may allow electrochemical reactions to be performed at the surface of the liquid metal. In the illustrated example, a single electrode 370 is present. The liquid metal 332 may serve as electrical ground, and thus the inclusion of more than one electrode is optional. Multiple electrodes may however be included if desired. The nature of voltage source 372 is not particularly limited. For example, the voltage source 372 may be a battery or a connection to an external power supply.

The example system further includes a dipping device 380, which in the illustrated example holds a dipping plate 382. The dipping device 380 is configured to move the dipping plate 382 vertically, to allow the dipping plate 382 to be immersed in or removed from the liquid metal 332. In particular, the dipping device 380 may be configured to lower dipping plate 382 into well or channel 334 of bath 330. The dipping device 380 may be useful for removing the layer of 2-dimensional material from the surface of the liquid metal 332. The dipping device 380 may also be useful in the magic angle process of FIG. 2. An example dipping device will be described in more detail later with reference to FIG. 4.

The system further comprises a monitoring unit 390. The monitoring unit 390 in this example includes a light detector 392 and a light source 394. The light source may be a laser or a maser.

The monitoring device 390 may in particular be a Raman spectrometer. Raman spectroscopy may be used to detect the formation of monolayers or products at the surface of the liquid metal 332. For example, the formation of a monolayer or a layer of product may result in a change detected in the Raman spectrum. Other detection devices may be used.

Various modifications may be made to the illustrated system.

As will be appreciated, FIG. 3 shows the system while in use, with liquid metal present in the bath and the dipping device fitted with a dipping plate. When not in use, the bath may be drained of the liquid metal, and the dipping plate may be absent.

Although the methods described herein may usefully be fully or partially automated, manual operation of the device is also contemplated. The control unit 320 may therefore be omitted.

Dispensing unit 340 may be omitted. Reagents may instead be applied by, for example, by pipetting or using a manual spray bottle by an operator. Providing an automated dispensing device may however be useful in implementations where a controlled atmosphere is desired.

The electrode 370 and voltage source 372 may be omitted in some implementations. For example, the system may be used to perform reactions which are initiated by mixing reagents and/or by applying radiation to the thin film. Providing means for performing electrochemical reactions is thus optional.

As an alternative or in addition to the dipping device, the system may comprise a suction device for removing the two-dimensional material from the surface of the liquid metal. An example suction device will be explained in more detail below, with reference to FIG. 5.

Ultrasonic generator 360 is optional and may be omitted in some implementations.

The well or channel 334 may be omitted. In such implementations, the depth of the bath is selected to be large enough to allow the dipping plate to be immersed in the liquid metal 332.

The example system has a single tray. Systems which include two or more trays are also contemplated. Where a plurality of trays is present, trays may be arranged side-by-side or one atop another.

The system may include one or more additional components in any appropriate combination, for implementing methods as described herein.

When in use, a mask may be arranged on the surface of the liquid metal, as previously described with reference to the method aspect.

The bath may be provided with additional components.

The bath may be provided with one or more heating elements for adjusting the temperature of the liquid metal. For example, one or more heating elements may be affixed inside and/or underneath the tray.

The bath may be provided with one or more cooling elements for cooling the liquid metal. Some liquid metals may remain in the liquid phase even below room temperature. For example, mercury has a melting point of about −39° C.

The bath may include a temperature measurement device for measuring the surface temperature of the liquid metal. For example, a thermocouple may be arranged at the upper surface of the liquid metal.

The bath may be furnished with a drainage system, for example one or more drains and/or one or more taps. A drain or tap for removing liquid metal from the bath may be provided. A drain or tap for removing liquid by-products, chemical washings, and/or cleaning agents may be provided. A drain for collecting any overflow from the bath may be provided.

The system may further comprise a pump for recirculating the liquid metal. Providing a flow of liquid metal may be useful in implementations where orienting linear polymer strands is desired. In particular, a recirculating liquid metal phase may be used to align polynucleotides such as DNA and RNA within an oriented external electric field applied across the surface.

One or more electrodes covered by electrical insulation may be arranged in the bath. The electrodes may be mounted on the side walls and/or base of the bath. Such electrodes may be useful for applying an OEEF to the surface of the liquid metal.

The electrodes may be operably linked to one or more signal generators. The one or more signal generators may comprise a pair of signal generators arranged at 60° to one another. The one or more signal generators may be Fourier signal generators.

Magnetic fields may be useful for aligning certain materials. The system may include one or more magnets for applying a magnetic field across the surface of the liquid metal. The one or more magnets may comprise one or more electromagnets. The one or more magnets may be mounted in the bath.

The system may include a surface heating device. For example, electric furnace heating elements may be arranged, e.g. suspended, above the bath.

An electromagnetic radiation source, for example a source of infrared, UV, or vacuum ultraviolet (“VUV”) radiation may be arranged above the bath. An infrared source may be useful for surface heating, e.g. flash surface heating. Another example of an electromagnetic radiation source is a xenon lamp.

As an alternative or in addition to a gas supply, the system may include an ozonizer for generating ozone in situ in the enclosure. An ozone supply may be useful for performing certain oxidation reactions.

The system may further comprise an electro-balance.

The system may further comprise a device for cutting two-dimensional materials. One example of such a device is a PTFE rod.

Any of the components described above may be fixed or mobile. If mobile, they may be configured to be moved manually by an operator, or automatically by one or more motors. The one or more motors may be controlled by control unit 320.

### Computer Program Product

The methods described herein may be automated, for example using the system 300.

To this end, there is provided a computer program product comprising instructions which, when executed by a processor (e.g., processing apparatus 322), cause one or more devices to perform a method as described herein.

The computer program product may be embodied on a non-transitory computer readable medium (e.g., data storage 324).

### Example Dipping Device

An example dipping device 400 which may be included in system 300 will now be described with reference to FIG. 4. FIG. 4 shows a schematic front view of the device 400.

The dipping device 400 is for raising and lowering a dipping plate 450, and for adjusting a yaw of the dipping plate 450.

The dipping device 400 includes a support 410, a first actuator 420 operably linked to a shaft 422 for raising and lowering the dipping plate 450, a frame 430 mounted on the shaft 422 for holding the dipping plate 450, and a second actuator 440 mounted on the frame 430 for adjusting a yaw of the dipping plate 450.

Support 410 is for holding the dipping device over a bath of liquid metal, e.g. bath 330 of system 300. The configuration of the support 410 is not particularly limited and may be varied as appropriate. In this example, the support comprises a bracket having screw clamps 412a, 412b at respective ends of the bracket. Screw clamps 412a, 412b may be used to clamp the bracket 410 to side walls of a bath.

In particular, the dipping device may be mounted over a well for receiving the dipping plate, such as well 334 of system 300.

An actuator 420 is mounted on the support 410. The actuator 420 is for driving the dipping plate 450 vertically into the bath of liquid metal. To this end, the actuator is configured to generate sufficient downward force to overcome the buoyancy of the dipping plate 450 in the liquid metal. The actuator may comprise a servomotor. Servomotors with working rates in the range 0.1 to 108 mm/min may be suitable. Such servomotors are commercially available.

A rigid shaft 422 extends downwardly from the actuator 420. A frame 430 is mounted on the shaft 422. Frame 430 is configured to hold a dipping plate 450, and to allow yawing of the dipping plate 450. Dipping plate 450 may be removably mounted on the frame 430, and may be absent when the device is not in use.

Frame 430 comprises first and second horizontal bars 431, 432. The first horizontal bar 431 is mounted on the shaft 422.

The second horizontal bar 432 is arranged below the first horizontal bar 431. Respective ends of the first and second horizontal bar are coupled by linkages. A hinged linkage 433, 434 connects one end of the first horizontal bar 431 to a corresponding end of the second horizontal bar 432. A telescoping linkage 435 connects the opposite ends of the first and second horizontal bars 431, 432. An actuator 440 for adjusting the length of the telescoping linkage is mounted on the first horizontal bar 431.

The hinged linkage 433, illustrated on the left-hand side of FIG. 4, comprises top and bottom rigid bars joined at a hinge 434. The top rigid bar is fixed to the first horizontal bar 431. The bottom rigid bar is joined to the second horizontal bar 432 via a hinge 436.

The telescoping linkage, on the right-hand side of FIG. 4, is fixed at one end to the first horizontal bar 431 and hingedly connected to the second horizontal bar 432 via hinge 437.

In the illustrated example, a dipping plate 450 is mounted on the second horizontal bar 432. The dipping plate may be fixed to the second horizontal bar, or may be removable from the second horizontal bar.

The dipping plate is a planar member, having two opposed major surfaces. The shape of the major surfaces is not particularly limited. For example, the dipping plate may be circular or rectangular. In this example, dipping plate 450 has a straight top, straight left and right sides, and a rounded bottom edge 452.

Providing a rounded bottom edge may allow the plate to be arranged closer to the walls of the bath while accommodating adjustments to the yaw of the plate.

The dipping plate comprises a rigid material, to allow the dipping plate to be driven vertically into a liquid metal. The nature of the rigid material is not particularly limited. The rigid material may be an organic polymer. A two-dimensional material may be separated from an organic polymer sheet by, for example, dissolving the organic polymer in an appropriate solvent.

Illustrative examples of useful rigid materials include polystyrene, polycarbonate, poly(methyl methacrylate). Poly(methyl methacrylate) is commercially available under the trade name Perspex®. The dipping plate may comprise two sheets of rigid material sandwiched together. In such implementations, the frame 430 may be configured to hold the sheets together mechanically. For example, second horizontal bar 432 may include a clamp for holding the sheets.

A coating may be provided on a surface of the dipping plate to improve adhesion of two-dimensional materials to the dipping plate. Examples of coating materials include poly(methyl methacrylate) or polystyrene. A further example of a coating material is polycarbonate.

Horizontal surface compression, e.g. using barrier device 350 of system 300, may be used to help to transfer the two-dimensional material onto the surface of dipping plate 450.

In use, the first actuator 420 is used to drive the frame 430 downwards, thereby forcing at least part of the dipping plate 450 into the liquid metal. The frame 430 is typically also driven into the liquid metal. The first actuator may then be used to drive the frame 430 upwards, withdrawing the dipping plate 450 from the liquid metal.

A two-dimensional material is formed on the liquid metal before or after lowering the dipping plate, as previously described with reference to FIG. 2. As the dipping plate moves up or down through the liquid metal, the two-dimensional material is transferred onto the dipping plate, more specifically onto the bottom edge and both major surfaces of the dipping plate. Two-dimensional materials do not adhere strongly to the surface of liquid metals, and removing two-dimensional materials from liquid metals in this way is typically straightforward.

The second actuator 440 may be used to adjust the length of the telescoping linkage. The hinged linkage bends at hinge 434 to accommodate the adjustment. This causes the dipping plate to rotate in the plane of the dipping plate, in other words adjusts the yaw of the dipping plate. This is useful in the “magic angle” process described above with reference to FIG. 2. The yaw of the dipping plate may be independently selected for each layer in the stack. The stack may include any number of layers.

When used in the preparation of a stack, the process may begin with the dipping plate in a raised position if a stack with an even number of layers is desired, or in a lowered position if a stack with an odd number of layers is desired.

After transferring a desired number of layers of two-dimensional material onto the dipping plate, the dipping plate may be removed from the dipping device. The two-dimensional material may then be removed from the dipping plate, for example by dissolving the dipping plate as described with reference to block 206 of FIG. 2.

### Example Suction Device

In addition or as an alternative to the dipping device, the system 300 may include a suction device. An example suction device 500 will now be described with reference to FIG. 5. FIG. 5 is a schematic perspective view of the suction device 500.

The suction device 500 comprises a hollow horizontal member 510 mounted on an actuator 520. The hollow horizontal member 510 of this example is in the form of a tube. The tube may be sealed at one end. The material from which the tube is formed is not particularly limited, with many metals and plastics being suitable.

A plurality of holes 512a, 512b, 512c are provided in the wall of the horizontal member 510. The holes may be arranged in one or more rows.

Actuator 520 is configured to move the horizontal member 510 in a vertical direction, and to rotate the horizontal member 510. Actuator 520 further includes or connects to a suction device, for sucking air through the plurality of holes 512a, 512b, 512c.

The suction device is useful for removing layers of two-dimensional materials, or stacks of such layers, from the surface of a liquid metal. In use, after synthesizing a layer of two-dimensional material on the surface of a liquid metal, horizontal member 510 is lowered to contact the surface of the liquid metal. Suction is applied. The horizontal member 510 is rotated while applying the suction. The two-dimensional material is drawn from the surface of the liquid metal.

The suction device may be computer controlled, for example operably linked to control unit 320 of system 300.

The suction device may be used to draw the two-dimensional material into a thread, fibre, composite wire, or rope.

Threads and fibres may be used in the manufacture of body armour or optical fibres, or wound into wire, rope, or cable.

In particular, threads, fibres or ropes of conductive two-dimensional polymers such as graphene may be formed. Graphene ropes are less dense than copper and steel ropes; strong compared with equal weights of steel and copper; and are better electrical conductors. Graphene ropes and cables may be used in electricity distribution networks and in power supply.

Moreover, graphene's high melting point and chemical stability under ambient conditions may permit it to be used in safely transporting high voltages.

As wires, graphene may be wound to form components of a wide range of devices such as solenoids, motors, reluctance motors and other reluctance devices, and aerial vehicles where the minimisation of weight is paramount, such as aeroplanes, drones, missiles and space vehicles.

Wires of any gauge may be obtained. For illustration, a graphene film of thickness 0.01 mm may be produced on a liquid metal substrate of width 1 m. The cross-sectional area of the graphene on the metal substrate may equal the cross-sectional area of wire:

$$wt = \frac{π {D}^{2}}{4}$$

where w and t are the width and thickness of the film and D is the wire diameter. Solving for D gives a wire diameter of about 3.5 mm, which is approximately equal to American Wire Gauge (“AWG”) 7.

Since visible light can travel along graphene wires, graphene may lend itself to use in fibre optic cable and to optical computing since it has a high refractive index to assist containment of the signal.

Graphene may permit the transmission of radio and television signal frequencies especially when these are placed upon a suitable carrier frequency.

### Composite Wire

An example composite wire based on 2-dimensional materials will now be described with reference to FIG. 11. FIG. 11 is a schematic cross-section of the composite wire 1100.

A composite wire 1100 comprises a plurality of concentric layers. At least one of the layers comprises a 2-dimensional material as described herein.

The illustrated example comprises a central core 1; three intermediate layers 2, 3, 4; and an outer layer 5.

The core 1 may comprise a composite thread, obtainable by forming a stack of two or more different two-dimensional materials, and winding the stack, e.g. using suction device 500. By way of illustration, core 1 may comprise graphene and boron nitride.

More generally, fibres may be formed from two-dimensional materials and spun into threads using any appropriate technique. Existing methods for spinning fibres into threads may be applied. Spinning together two or more threads comprising different materials may allow synergistic effects to be obtained. For example, spinning together graphene and boron nitride fibres into a composite thread may provide enhanced properties.

Any number of intermediate layers 2, 3, 4 may be formed around the core, for example by wrapping one or more layers of one or more materials around the core 1. Each intermediate layer may comprise a 2-dimensional material or stack of 2-dimensional materials.

Layers may have different optical properties. For example, first intermediate layer 2 may be selected to have a refractive index which is different from that of core 1. The composite wire 1100 may be configured as a fibre-optic cable, with core 1 serving as a fibre-optic core and first intermediate layer 2 serving as fibre optic cladding.

Other configurations are possible. For example, second intermediate layer 3 may serve as a fibre-optic core, with first and third intermediate layers 2, 4 serving as fibre-optic cladding.

Layers may have different electrical properties. For example, core 1 may comprise an electrically-conductive 2D material, such as graphene, and first intermediate layer 2 may comprise an electrically-insulating 2D material, such as boron nitride.

Outer layer 5 in this example is an optional protective layer. The protective layer 5 may be referred to as an outer sheath or insulating layer. The protective layer 5 shields the core and intermediate layers from the external environment. Protective layer 5 may comprise any suitable protective material. The protective material may comprise a 2D material, or a conventional protective material known in the field of cabling (e.g., a polymer coating).

By selecting the number of layers of material and their natures, composite cables having various different properties may be obtained.

For example, a composite cable comprising at least one electrically-conducting material surrounded by at least one electrically-insulating material may be useful for conducting electricity. Such a cable may be useful for electrical power distribution and/or for transmitting electrical signals (e.g., for telecommunications).

A composite cable comprising two or more materials having different refractive indices may be configured as a fibre optic cable. Fibre optic cables may be useful for transmitting optical signals (e.g., telecommunications signals and/or signals within an optical computer). By way of illustration, an example fibre optic cable comprises a graphene core and a graphene oxide layer arranged around the graphene core. Graphene oxide has refractive index which is lower than that of graphene.

Composite cables comprising any number of layers of any number of different 2D materials may be produced using the methods provided herein. This may allow for the production of multi-function composite cables, capable of carrying both electricity and light (e.g., fibre-optic communications) simultaneously. The composite cables may allow for rapid deployment of new infrastructure, particularly in the developing world since the methods described herein may allow for relatively low cost manufacture of composite cables.

### Two-Dimensional Materials

The methods and systems provided herein may be used to synthesize a wide range of different two-dimensional materials. The two-dimensional material may comprise a single element, a mixture of elements, or a compound. The compound may be an organic compound or an inorganic compound. The two-dimensional material may be doped.

The two-dimensional material may comprise a network of 6-membered aromatic rings. The rings may be fused rings. Alternatively, the rings may be connected by bonds or by linking groups.

### Graphene and Derivatives Thereof

The two-dimensional material may be an optionally-doped, optionally-porous, optionally-substituted graphene. As used herein, a “doped graphane” is a graphane analogue which includes heterocycles. A substituted graphane is a graphane analogue in which some or all of the hydrogen atoms are replaced with functional groups.

One example of a substituted graphane is perfluoro graphane, where all H groups in the graphane are replaced with F. Perfluorographane may be useful as a dielectric material.

Graphane and derivatives thereof are obtainable by anodic oxidation of precursors according to Formula:

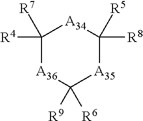

wherein:
R4, R5 and R6 are each polymerizable groups selected from carboxylic acid groups; hydroxyl groups; acyl halide groups; ethyne groups;
R7, R8, and R9 are each independently selected from H and X;
A34, A35, and A36 are each independently selected from O, S, CH₂, CHX, and CX₂;
where X represents a substituent selected from a halogen, an alkyl group having 1 to 3 carbon atoms, an alkyl ether having 1 to 3 carbon atoms, an alkyl ester having 1 to 3 carbon atoms, a nitrile group, a nitro group, a nitrite group, a sulfonate group. When more than one X group is present, each X group may be independently selected.

In particular R4, R5 and R6 may be carboxylic acid groups.

Different substituents may create different size pores. Porous graphane may be useful for, for example, filtration and particularly for water desalination.

Graphane is obtainable by anodic decarboxylation of cyclohexane-1,3,5-tricarboxylic acid.

### Graphene and Derivatives Thereof

The two-dimensional material may be an optionally-doped, optionally-porous graphene. The dopant may be any of the dopants identified above. Porous graphenes and doped porous graphenes may be optionally-substituted. Graphene and its derivatives may be electrically-conductive, and may be used as electrodes.

A fragment of an infinite two-dimensional graphene sheet is illustrated in FIG. 6. Graphene is one example of an electrically-conductive material having delocalised electrons.

The methods provided herein may be used to synthesise network polymers comprising units as defined in the following formula:

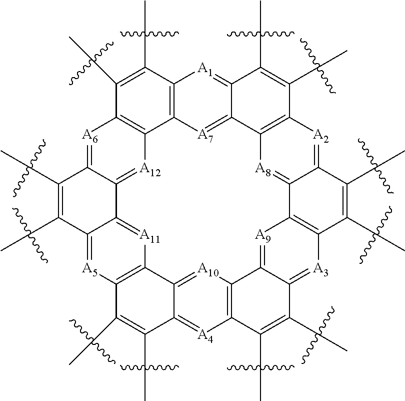

where: A1 to A12 are each independently selected from CH, CR4, N, NR5, P, As, Sb, Bi, O, S, Se, and Te. A1 to A12 are preferably each independently selected from CH, CR4, N, and NR5.

R4 may be any appropriate substituent. For example, R4 may be selected from a halogen, a carbonyl oxygen, alkyl groups, alkyl ethers, alkyl esters, nitrile, nitro, nitrite, or sulfonate. In particular, R4 may be a halogen, a carbonyl oxygen, or an alkyl group having 1 to 3 carbon atoms.

R5 may similarly be any appropriate substituent. For example, R5 may be an alkyl group, optionally an alkyl group having 1 to 3 carbon atoms, and further optionally a methyl group.

Two-dimensional polymers which include a mixture of different units according to Formula 1 are contemplated. The two-dimensional material may include porous graphene units, in which all of A1 to A12 are CH; substituted porous graphene units, in which at least one of A1 to A12 are CR4; doped porous graphene units, in which at least one of A1 to A12 comprises a heteroatom; and substituted doped porous graphene units.

One example of a material according to Formula 1 is porous graphene, in which A1 to A12 are all CH.

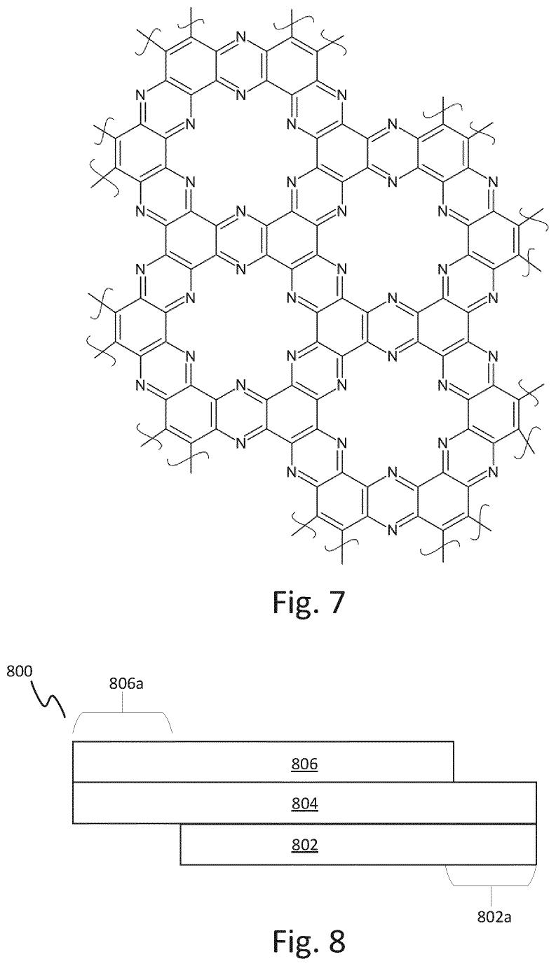

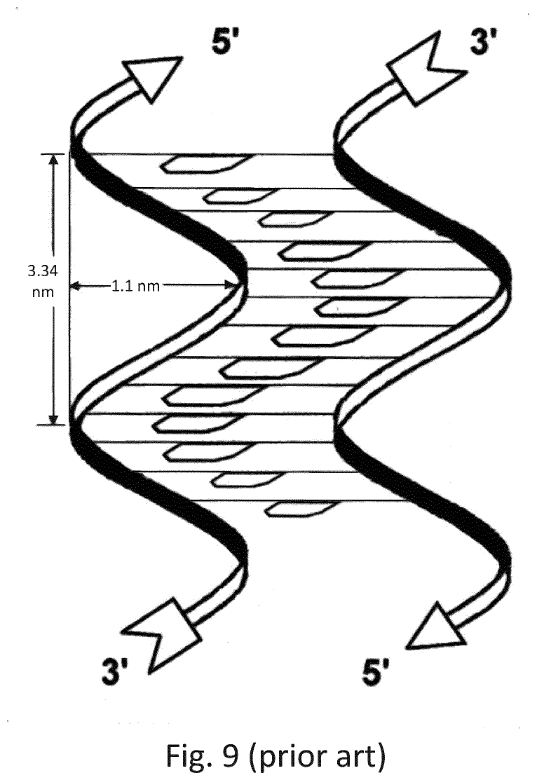

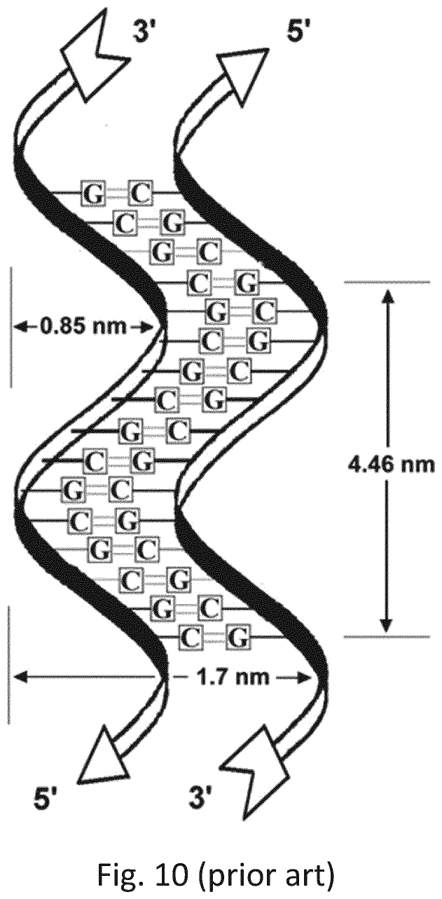

In another example, A1 to A12 are each individually selected from N and NR5. In one more specific example, A1 to A12 are all N; this material is referred to informally herein as “porous quinoxaline-graphene”. The structure of a fragment of an infinite sheet of porous quinoxaline-graphene is illustrated in FIG. 7. As described in more detail below, porous quinoxaline-graphene and its alkyl derivatives have various possible uses.

Porous quinoxaline-graphene may release electrons as an anode in a battery. Porous quinoxaline-graphene may store and release interstitial electrons as a capacitor. Porous quinoxaline-graphene may catalyse reactions due to its imposed high voltage. Porous quinoxaline-graphene may act as a redox electrode. Porous quinoxaline-graphene is capable of coordinating many different metal atoms and ions. Examples include Ti, Zr, Hf, V, Nb, Ta, Cr, Mo, W, Mn, Re, Fe, Ru, Os, Co, Rh, Ir, Ni, Pd, Pt, Cu, Ag, and Au. Further examples include Th and U.

Composed solely of C and N, 2D porous quinoxaline-graphene formed on liquid metal may be nearly monoisotopic. Porous quinoxaline-graphene may coordinate square planar monoisotopic species such as Co and dicobalt, from cobalt tricarbonyl nitrosyl and dicobalt octacarbonyl respectively, forming a “spintronic” substrate. Other examples of monoisotopic elements which may be used include beryllium, sodium, aluminium, scandium, manganese, yttrium, niobium, rhodium, caesium, praseodymium, terbium, holmium, thulium, gold, bismuth and thorium.

Porous quinoxaline-graphene is obtainable by condensation of phloroglucinol (i.e., benzene-1,3,5-triol) and hydroxylamine with aqueous KOH on a liquid metal. Mercury is a preferred liquid metal for this process, since mercury resists alkalis. Residual hydrogen atoms may be removed by heat in the presence of oxygen (e.g., exposure to air at a temperature of about 80° C.).

In still another example, A1 to A12 are all CR4, where R4 is a carbonyl oxygen. This polymer has a structure as shown below, and is referred to herein as “net poly(benzoquinone)”:

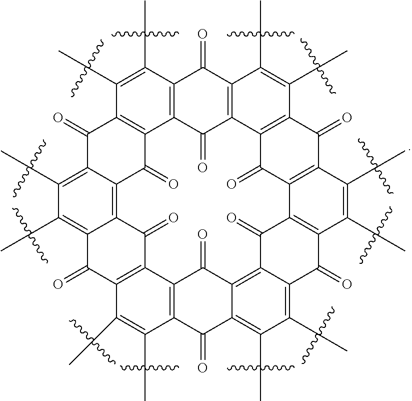 [SMILES: *c1c(*)c2c(=O)c3c(*)c(*)c4c(=O)c5c(*)c(*)c6c(=O)c7c(*)c(*)c8c(=O)c9c(*)c(*)c%10c(=O)c%11c(*)c(*)c%12c(=O)c1c1c(=O)c%12c%11c(=O)c%10c9c(=O)c8c7c(=O)c6c5c(=O)c4c3c(=O)c21]

This polymer may be useful as a cathode material for an all-polymer energy storage device. The polymer of may be obtained by exposing 2,4,6-triiodobenzene-1,3,5-triacyl iodide to UV irradiation, e.g. using a Xenon lamp, on the surface of a liquid metal, followed by heating in the presence of oxygen to oxidise the resulting product to a quinone.

An alternative route for obtaining a similar polymeric 1,4-benzoquinone is to perform anodic decarboxylation of 2,4,6-tribromo-1,3,5-tricarboxylic acid, followed by displacement of the bromine by —OH from ethanolic KOH solution, and oxidation with aqueous H₂O₂.

Graphene and graphene derivatives may be treated with ozone and ultraviolet radiation in situ on the surface of the liquid metal to generate graphene oxides. Graphene oxides may be treated with reducing agents, such as N,N-dimethylhydrazine to form reduced graphene oxide. Lawesson's reagent may alternatively be used to reduce graphene oxide.

Precursors useful for forming graphene and its derivatives typically comprise a 6-membered aromatic ring with three reactive groups, arranged meta to one another. In other words, reactive groups are provided at either all of the 1, 3 and 5 positions, or all of the 2, 4, and 6 positions. The remaining three positions in the ring may each individually be unsubstituted, substituted, or occupied by a heteroatom.

In particular, graphene and its derivatives may be synthesised from compounds according to Formula:

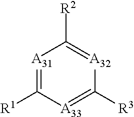

where:
R1, R2, and R3 are each carboxylic acid groups or acyl halide groups, preferably carboxylic acid groups;
A31, A32 and A33 are each independently selected from N, CH, and CR4, where R4 is a substituent selected from a halogen, an alkyl group having 1 to 3 carbon atoms, an alkyl ether having 1 to 3 carbon atoms, an alkyl ester having 1 to 3 carbon atoms, a nitrile group, a nitro group, a nitrite group, a sulfonate group, —CNO, —OCN, —CNS, and —SCN.

Monomers according to this formula, having three carboxyl groups or three acyl halide groups arranged meta to one another, may be coupled by anodic decarboxylation. Monomers comprising acyl halide groups may undergo hydrolysis prior to coupling by anodic decarboxylation.

In other variants, R1, R2, and R3 may each be hydroxyl groups, ethyne groups, aldehyde groups, or oxime groups. Where R1, R2 and R3 are hydroxyl groups, the liquid precursor composition may further comprise hydroxylamine.

One example monomer is 1,3,5-tribromobenzene-2,4,6-tricarboxylic acid.

Graphene derivatives may be synthesized from mixtures of monomers according to Formula 1. For example, nitrogen-doped graphene derivatives are obtainable by anodic decarboxylation of a mixture of pyridine-2,4,6-tricarboxylic acid with a further monomer.

Another example dopant is 1,3,5-trioxane-2,4,6-tricarboxylic acid, which may optionally be supplied as its potassium salt.

### Net Poly(Benzene) and Derivatives Thereof

Still another class of organic two-dimensional materials which may be synthesised using the methods and systems disclosed herein are the net poly(benzene) analogues and derivatives defined in the following formula:

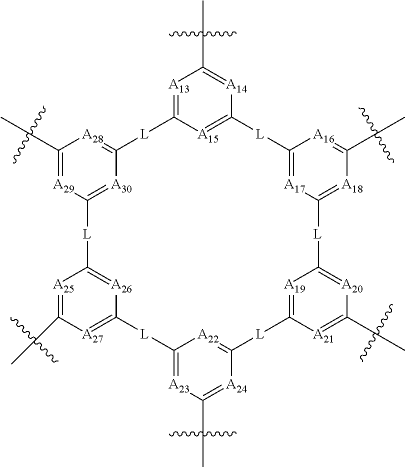

wherein:
each L is a linker selected from a bond, —C≡C—, —C≡C≡C≡C—, O, and S; and
A13 to A30 are each independently selected from CR6, N, N-alkyl, P, As, and Sb.

Each R6 group, where present, may be independently selected from —H, halogens, alkyl groups, alkyl ethers, alkyl esters, nitrile groups, nitro groups, nitrite groups, sulfonate groups, and —CHO.

A13 to A30 are optionally selected from CR and N.

Where an alkyl substituent is present, the alkyl substituent may have from one to three carbon atoms, and is preferably a methyl group.

When L is-C≡C—, the material may be referred to as a graphidyne. Graphidynes are obtainable from the corresponding triethane using a Cu(I) catalyst in the Glaser-Hay method.

Graphidynes have very large pores. Metal clusters and mixed metal clusters may be accommodated within the pores, particularly where some or all of A13 to A30 are group 15 elements (N, P, As, Sb). The group 15 element may coordinate to the metal cluster, tethering the metal cluster to the polymer. For example, U and Th carbonyl complexes and simultaneously Pt and Pd carbonyl complexes bind to each other in mixed metal carbonyl clusters and to N and other ligand atoms.

L may be —C≡C— and each of A13 to A30 may be N. This 2-dimensional material is obtainable by the Glaser-Hay reaction of 2,4,6-s-triazine-1,3,5,-triethane on the surface of a liquid metal.

Alternatively, L may be a bond.

In one example, L is a bond and each of A13 to A30 is N. This material may be referred to as net poly(s-triazine). The material may be useful for binding metals, such as cobalt. The material may be useful as an anode of an all-polymer battery. The compound is obtainable by anodic decarboxylation of sym-triazine-2,4 6-tricarboxylic acid on the surface of a liquid metal.

In another example, L is a bond and each of A13 to A30 is C—CN. This material may be referred to as net poly(2,4,6-thiocyanobenzene), and is obtainable by anodic decarboxylation of 2,4,6-tricyano-benzene-1,3,5-tricarboxylic acid. Net poly(2,4,6-tri cyanobenzene) is an intermediate product which may be further processed to produce graphene: the cyano groups may be reduced to form primary amine groups, the amine groups may be oxidised to form alcohol groups using e.g. nitrous acid, and further to aldehyde groups which may then undergo aldehyde benzoin condensation followed by reduction to form non-porous graphene. The oxidation of the alcohols to aldehydes may be performed using excess nitrogen dioxide gas, as described by Naimi-Jamal et al. in “Sustainable Synthesis of Aldehydes, Ketones or Acids from Neat Alcohols Using Nitrogen Dioxide Gas, and Related Reactions” (ChemSusChem 2009, 2, 83-88; doi 10.1002/cssc.200800193).

Other routes from nitrile groups to aldehyde groups may be used.

One example is the Stephen aldehyde synthesis. This reaction involves the preparation of aldehydes (R—CHO) from nitriles (R—CN) using tin(II) chloride (SnCl₂), hydrochloric acid (HCl) and quenching the resulting iminium salt ([R—CH═NH₂]+Cl—) with water (H₂O). This route may avoid a need for LiAlH₄, which is expensive, and the use of nitrogen oxides, which are difficult to control.

Still another example approach for obtaining aldehydes from nitriles is to use a mild reducing agent such as diisobutylaluminium hydride (“DIBAL”).

### Further Polymers

Still another polymer obtainable by the methods provided herein is a cross-linked polymer comprising chains of formula:

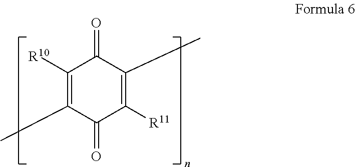

where R10 and R11 are each independently selected from H, O—R12, halogens e.g. F, and a nitrile group, with the proviso that at least one of R10 and R11 is H or O—R12. R12 represents a C1 to C3 alkyl group.

### Polynucleotides

The two-dimensional material may comprise a sheet of cross-linked polynucleotides. Such sheets may be useful in sensors, medical diagnostic tools and detectors of bacteria, viruses, and nucleic acids of complementary sequence, as well as for the fractionation of carbon nanotubes.

### Inorganic Two-Dimensional Materials

The methods provided herein are not limited to the synthesis of organic 2-dimensional materials. Inorganic two-dimensional materials may be formed on the surface of a liquid metal.

Examples of inorganic two-dimensional materials include two-dimensional layers of metals selected from Ni, Pd, Pt; Cu, Ag, Au; Ti, Zr, Hf; V, Nb, Ta; Cr, Mo, W; Mn, Re; Fe, Ru, Os, Co, Rh and Ir. Further examples include two-dimensional layers of metals selected from U and Th. Two-dimensional layers of these metals are obtainable by electrodeposition from an aprotic solvent onto a conductive two-dimensional polymer, such as graphene or porous quinoxaline-graphene or their derivatives.

Two-dimensional layers of certain metals are obtainable by thermal decomposition of metal ammines, carbonyls, or nitrosyls. Examples of such metals include Cr, Fe, Co, Ni, Cu and Zn. Such layers may be formed over layers of other two-dimensional sheets, which may be electrically-conductive (e.g., graphene) or a dielectric (e.g. boron nitride).

Two-dimensional metal oxide layers may be obtained by heating metal layers in the presence of oxygen. For example, copper or zinc oxide layers may be formed. In the case of copper, a Cu₂O phase may be formed by annealing at 200° C., while CuO films may be obtained by annealing at temperatures above 300° C. For zinc, annealing may be performed at temperatures in the range 250 to 450° C. to form a zinc oxide thin film.

Carbonyls and nitrosyls may alternatively be used as precursors for forming metal layers, optionally on graphene. For example, cobalt tricarbonyl nitrosyl, Co(CO)₃(NO), may be decomposed by heating in a dry inert gas.

Analogues of graphene which are based on other elements may be synthesized. Examples of such materials include borophene, silicene, phosphorene, germanene, arsenane, antimonene, bismuthane, selenane, and sulfurane. These materials may be deposited from aprotic solvents by electrolysis. Silicene and germanene may be of particular interest. Silicene or germanene may be deposited as the uppermost layer of a composite stack. The stack may then be inverted to obtain a structure resembling silicon transistor technology.

Two-dimensional inorganic compounds may be synthesised by the methods provided herein. Examples include boron nitride; boron phosphide; and silicon-germanium. Further examples include metal dichalcogenides of formula MXY, where M is a transition metal and X and Y are chosen from S, Se and Te and X and Y can be the same.

Silicon, optionally microcrystalline silicon, may be formed using the methods provided herein, e.g. by irradiating a suitable precursor.

Graphene analogues and two-dimensional inorganic compounds may be obtained by thermal deposition from a mixture of a hydrogen donor and a halogen donor. Examples of suitable hydrogen donors include LiAlH₄, NaBH₄, PH₄I, NH₄Cl, (Me)₃CNH₂, NH₃BH₃, (Me)₃NBH₃, (Me)₄NBH₄. Examples of halogen donors include Me₂S·BCl₃, BCl₃, PCl₃, POCl₃, PCl₅, AsCl₃, SbCl₃, BiCl₃. The hydrogen donor and the halogen donor may be selected as appropriate depending upon the product desired.

Further illustrative examples of materials obtainable by thermal decomposition from a mixture of a hydrogen donor and a halogen include indium, lead, tellurium, tin, zinc, and oxides thereof.

Specific examples of two-dimensional inorganic compounds are those obtainable by reactions of (Me)₄NBH₄ with one or more salts selected from AsCl₃, SbCl₃ and BiCl₃. Dry diethyl ether is a suitable solvent for performing reactions of these compounds.

A useful property of each of P, As and Bi is that their nuclei are all monoisotopic. When combined with ¹⁰B, or ¹¹B a monoisotopic 2D substance is formed which may allow for quantum entanglement and quantum coherence, that is, signalling between nuclei. Such substances may be useful in the fields of quantum computing and nuclear spintronics.

### Stacks and Composites

The methods provided herein may be used to prepare stacks comprising two or more layers of two-dimensional materials. A stack which contains layers of two or more different two-dimensional materials is referred to herein as a composite.

Stacks may include other materials arranged between the layers of two-dimensional material. Of particular interest are CrSBr flakes which can induce a magnetic response from bilayer graphene. In an example, under oxygen-free dry air, dry diglyme is saturated with chromium carbonyl and sprayed onto a boron nitride layer lying on liquid Wood's Alloy or a similar mixture of metals. Onto this is sprayed sulfur bromide (S₂Br₂) at RTP and the whole held under intense UV radiation at 50° C. for up to 10 hours. The temperature is raised slowly to 150° C. for 2 hours and then to approximately 175° C. to vaporise any residual diglyme.

A layer of large area graphene is laid upon the composite which can be recovered, for example on a dipping plate, turned over and laid upon a fresh layer of graphene to complete the bilayer in a manner analogous to the Langmuir-Schaefer method of the horizontal formation of composites.

### Liquid Metals

In the methods described herein, two-dimensional materials and stacks of two-dimensional materials are synthesized on the surface of a liquid metal substrate.

A liquid metal may provide a surface which is flat, uniform, and free from protrusions. The need to prepare a solid substrate having a pristine crystal face, as in CVD, is avoided.

In contrast to the solid crystalline substrates used in CVD, there is no particular constraint on the size of the liquid metal surface. Surface areas of the order of square meters are easily achievable. This may allow for the synthesis of two-dimensional materials or stacks having large surface areas, for example large enough for use to cover a solar panel or as a component of a display device.

Products which are formed on a liquid metal may be largely or completely free of wrinkles, creases, cracks, protrusions and/or folds. Without wishing to be bound by theory, it is believed that adjacent areas of product on a liquid surface can move easily, thereby allowing the relief of internal strains and stress. The use of ultrasonic waves or annealing at the surface may allow more effective relief of internal strains and stress, particularly where used in combination with compression.

Liquid metals have high density compared to water. Typically, products formed on a liquid metal will stay floating. Many organic and ionic chemicals are essentially insoluble in and immiscible with liquid metals. Two-dimensional materials are usually insoluble in liquid metals.

Generally, products do not adhere strongly to the surfaces of liquid metals. The product may be readily removable from the surface. For example, the product may be removed from the surface by the methods of Langmuir and Schaefer. Alternatively, the product may be pulled off by suction, without necessarily requiring compressive force. The ease with which the product may be removed from the surface may allow for automation of the processes provided herein.

Monomer components can be uniformly spread on the surface. This may, for example, minimise protrusions. Upon liquid surfaces, atoms and molecules can move or be moved into orderly and aggregated films of great area, high crystallinity, and good quality. For example wetting agents, ultrasonics, near infra-red radiation and/or surface movable barriers may be used to manipulate surface layers. The liquid metal may be continuously recirculated to allow for the production of long molecules and ribbons which are linearly aligned.

Liquid metals are typically not reactive under the conditions used for the synthesis of two-dimensional materials and stacks. Purity of the surface may be easily maintained, especially in low oxygen gas mixtures or under inert gases. The liquid metal is generally not consumed, and may be re-used many times.

Liquid metals typically have high thermal conductivity, a high heat capacity, and a high boiling point. Operations such as annealing or sintering may therefore be performed in situ on the liquid metal. Where a stack is formed on the liquid metal, the top layer of the stack may be annealed or sintered in situ.

The liquid metal may act as a heat sink. Annealing may be performed in a localized surface area without heating the entire system to the annealing temperature. Techniques such as flash heating may be used, since the liquid metal may rapidly conduct heat away from the product.

The surface of the liquid metal may be electrically conductive. In contrast to solvents such as water, liquid metals typically do not undergo electrolysis. Electrochemical reactions such as electrolytic condensation may therefore be performed on the liquid metal surface.

The surface may transmit electric fields and magnetic fields. The surface may transmit ultrasonic waves. The surface may have good tolerance to electromagnetic radiation such as ultraviolet radiation, (UV A, B, C, including VUV) or X-rays. A broad range of conditions are achievable at a liquid metal surface, allowing many different reactions to be performed.

Examples of suitable liquid metals include mercury; mercury amalgams often with small components such as gold and silver; and metallic gallium. Other examples include low-melting metal mixtures, such as certain indium and bismuth alloys and “Galinstan®”, a commercial range of low-melting mixtures based upon gallium, indium, and tin, sometimes together with lesser components such lead and bismuth.

Illustrative examples of liquid metals which may be used in the practice of the methods provided herein are set out in the table below.

| | | | Main | |
|---|---|---|---|---|
| | Melting | Boiling | Components/ | |
| Name | Point/° C. | Point/° C. | wt. % | Comments |
| Mercury | −39 | 356 | 100 | Low reactivity, |
| | | | | Resists alkalis |
| Galinstan ® | about −19 | >1300 | Ga 68.5 | In & Ga are |
| (Typical | | | | |
| Range) | | | In 21.5 | expensive & rare |
| | | | Sn 10.0 | |
| Indium Corp | 8 | | Ga 61, In 25 | In & Ga are |
| 46L | | | Sn 13, Zn 1 | expensive & rare |
| Indium Corp | 11 | | Ga 62.5, | In & Ga are |
| 51 | | | Sn 16, In 21 | expensive & rare |
| Indium Corp | 16 | | Ga 75.5 | In & Ga are |
| 60 | | | In 24.5 | expensive & rare |
| Bismuth based | 47 | | Bi 44.7, | In is rare & |
| (Belmont) | | | Pb 22.6, | expensive |
| | | | In 19.1, | |
| | | | Sn 8.3, Cd 5.3 | |
| Field's Metal | 62 | | Bi 32, In 51 | In is rare & |
| | | | Sn 16.5 | expensive |
| Wood's Metal | 70 | | Bi 50, Pb 27 | |
| | | | Sn 13, Cd 10 | |
| Rose's Metal | 98 | | Bi 50, Pb 28 | |
| | | | Sn 22 | |

Mercury is preferred in some implementations. Mercury has the useful property of resisting attack by alkaline reagents. Mercury is known to have a toxic vapour, but equipment capable of trapping mercury vapour and recovering liquid mercury with high efficiency is available.

Wood's metal may be preferred in other implementations.

In implementations where gallium is present in the liquid metal, the methods are preferably performed under inert gas, since gallium may react with oxygen.

A smooth surface for depositing substances has been created in other processes using molten metals (e.g., molten iron) as the substrate. The temperatures used in such processes are typically above 400° C. Maintaining metals at such high temperatures is expensive and thermally wasteful, as well as posing a significant hazard in the event of an accident. Furthermore, few products are chemically stable at such high temperatures, even under inert gas or in vacuo.

Liquid metal substrates may be operated at far lower temperatures than molten metals, that is from or near ambient temperatures (e.g., at room temperature, which is typically in the range 18 to 25° C.), up to and including 250° C. and at or near atmospheric pressure which offer the possibility of forming extended, smooth, uniform, high quality products.

The liquid metals used herein preferably have melting points of less than about 100° C. The methods described herein are typically performed at temperatures less than or equal to 250° C. The surface temperature of the liquid metal may exceed 250° C. for a brief time (e.g., less than 1 minute, or less than 30 seconds) e.g. during annealing or sintering processes or where flash surface heating is used.

Processes performed on the surface of aqueous media, using the well-known Langmuir-Blodgett trough, have also been reported. However, such processes suffer from many constraints. Water is a very good solvent and has a relatively low density. Many reagents will dissolve or sink in water, limiting the range of reactions which can be performed at the surface of the water. In addition, reaction conditions are limited: water has a relatively low boiling point, and begins to electrolyse if subjected to voltages greater than about +2 V.

Furthermore, in aqueous solutions the surface layer of product is usually composed of molecules which are generally not chemically combined with their neighbours. Removal of surface films from aqueous media typically requires the Langmuir or Schaefer techniques, involving compression of the surface film.

Liquid metals in comparison have high density, are immiscible with many reagent solutions, and tolerate high voltages. The products formed by the present methods comprise contiguous molecules, typically polymers, which float on and are easy to remove from the surface.

### Energy-Storage Device

The methods provided herein may be used in the manufacture of an energy storage device, such as a battery or capacitor.

An example energy storage device is illustrated in FIG. 8. The device includes an anode 802, a cathode 806, and a dielectric 804 sandwiched between the anode 802 and the cathode 806.

In the illustrated example, the anode 802 and cathode 806 each include respective margins 802a, 806a. The margins are portions of the anode and the cathode which extend beyond the ends of the dielectric 804. The margins are arranged at opposite sides of the device. This may allow an electrical connection for the anode and an electrical connection for the cathode to be attached to the device more easily.

The anode and cathode each comprise two-dimensional materials obtainable by the methods described herein. The dielectric may comprise a two-dimensional material obtainable by the methods described herein. Conveniently, the anode, cathode and dielectric may be fabricated as a stack. In a variant, the dielectric may comprise a conventional material obtained by a different manufacturing method.

The anode may comprise one or more two-dimensional layers of a conductive polymer comprising units of formula:

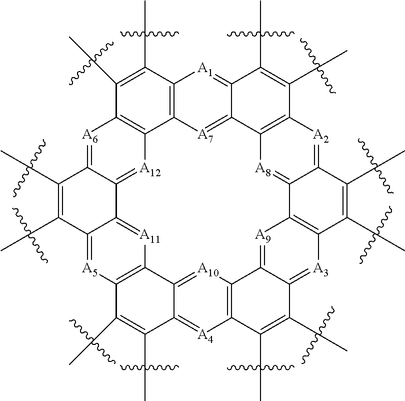

wherein A1 to A12 are each individually selected from N and N—R, where R is a C1 to C3 alkyl group, preferably methyl. If more than one R group is present, each R group may be individually selected.

Alternatively, the anode may comprise one or more two-dimensional layers of a conductive polymer comprising units of formula:

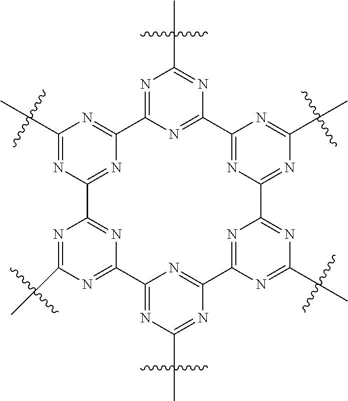

The cathode may comprise a layer or stack of layers of a conductive polymer comprising units of formula:

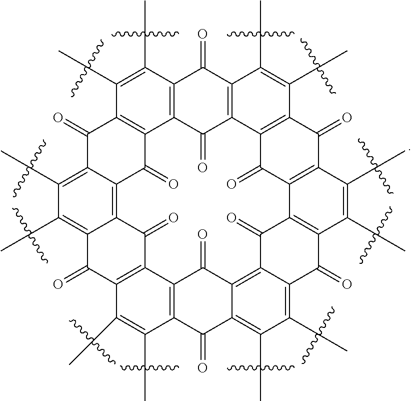

Constructing the anode and cathode from polymeric materials may allow for rapid charging and discharging of the energy storage device since charging and discharging involve movement of electrons only, and not metal ions or other electrolytes such as hydrogen ions.

In particular, the anode may comprise porous quinoxaline-graphene and the cathode may comprise net polycyclobenzoquinone.

The anode may comprise a composite stack comprising a redox pair of polymers. The cathode may comprise a composite stack comprising a different redox pair of polymers.

The nature of the dielectric is not particularly limited. Examples of dielectrics obtainable by the methods provided herein include boron nitride and perfluorinated graphane.

Contact between layers may be improved by providing organic carbonates between the layers. Examples of useful organic carbonates include ethylene carbonate and propylene carbonate. Further, a few drops of dimethoxymethane may be beneficial.

Carbon nanotubes, which may be single-wall carbon nanotubes, multi-wall carbon nanotubes, or a mixture thereof, may be provided between layers to improve performance of the energy storage device.

The energy storage device may be free of an electrolyte. The energy storage device may be free of an electrolyte solution, and may be free of a solid electrolyte.

The energy storage device may be referred to as an “all-polymer battery” or “all-polymer capacitor”. By “all-polymer” is meant that the active components of the device, i.e. the anode and cathode, are substantially free of metal atoms and metal ions and the charge-discharge cycle does not involve the movement of metal ions. In particular, the anode and cathode may be free of lithium ions.

The term “all polymer” does not exclude the presence of, for example, connectors or packaging comprising metal. For example, the device may include metal contacts for allowing electrical connection of other components to the energy storage device.

The energy storage device may be included in an electric vehicle or hybrid vehicle. For example, the energy storage device may be used as a component of a regenerative braking system.

The energy storage device may be electrically connected to a photovoltaic cell for charging the energy storage device.

As will be appreciated, FIG. 8 is a simplified schematic diagram and many variations are possible. The anode, cathode and/or dielectric may comprise more than one layer of material. In particular, the anode and cathode may each be composite stacks, comprising different respective redox pairs of conductive polymers. Additional dielectric layers may be present, e.g. at the top and bottom of the device. The device may be in the form of a stack, comprising a plurality of anodes and cathodes. The anode, cathode and dielectric may be flexible. The device may be rolled up and arranged in protective packaging. The inclusion of margins 802a, 806a is optional.

Other types of energy storage devices include graphene batteries. A graphene battery may include graphene or a derivative thereof, optionally in combination with one or more anode materials such as porous quinoxaline-graphene or net polycyclo-s-triazine; and/or one or more cathode materials such as methoxy polybenzoquinone (more specifically, methoxy polycyclobenzoquinone) and net polycyclobenzoquinone.

### Further Devices Incorporating Two-Dimensional Materials

The methods provided herein may be used in the manufacture of a wide variety of products.

Semiconductor devices or components thereof may be manufactured. Diodes, such as light-emitting diodes, optionally organic light-emitting diodes may be manufactured. Thin film transistors may be manufactured. Combinations of semiconductor components may be manufactured.

Photovoltaic cells may be composed wholly or partially of polymers manufactured upon a liquid metal substrate. In particular, the surface of the photovoltaic cell which is configured to receive incident light may be composed wholly or partially of the polymer. Alternatively, polymer coatings may be added to the surface after manufacture. The coating may be attached using a fixative, such as poly(methyl methacrylate).

Providing a two-dimensional material on a surface of a photovoltaic cells or solar panel may reduce reflection, thereby increasing energy conversion efficiency. Graphene bilayers or trilayers may be used.

Water, e.g. rainwater, running across a conductive polymer surface may generate a charge. Materials obtainable by the methods provided herein may be used in devices for generating electricity from flowing water, e.g. across a surface of a solar cell.

Germanium layers formed upon graphene may offer anti-bacterial activity.

Silicon and/or silicon oxide layers produced by the methods may be useful in electronic devices. In particular, such layers may be useful as back panels for thin-film transistors, e.g. in a thin film transistor display. The silicon and silicon oxide layers may be flexible.

The materials provided herein may be useful for coating display devices, e.g. displays of mobile telephones, computer monitors and televisions.

Threads may be drawn from two-dimensional materials, e.g. graphene lying upon liquid metals by lifting one edge of the surface film and rotating and pulling that edge. Such a thread may be wound into fibre, then into yarn, fabric, rope, or cable. A variant of this process may be used to form a composite cable of the type described with reference to FIG. 11 by sequentially synthesising and drawing two-dimensional materials.

A fabric comprising a graphene stack supports body armour. A fabric comprising a graphene stack may discharge static electricity. The ability to discharge static electricity is a useful property in potentially explosive environments, such as oil refineries or chemical works.

Graphene is a better electrical conductor than copper and aluminium, and is stronger than steel. In addition, graphene has a high transmittance for electromagnetic radiation, especially visible light. Fibres, yarns, and ropes made from graphene and its derivatives may be used in electricity transport and distribution.

Graphene has high optical transparency and a high refractive index. Graphene fibres or strings may be used as components of optical fibres. Optical fibres may be useful e.g. for transmitting data in communications networks.

The electrical and optical properties of graphene and its derivatives may be exploited simultaneously, for example by providing a composite cable as described with reference to FIG. 11.

The materials provided herein may be used as substrates for templating other materials. For example, a two-dimensional hybrid organic-inorganic perovskite may be templated onto graphene. In addition, a composite bilayer for example may be composed of graphene and boron nitride. When a bilayer is spun or drawn into a wire, a composite wire is formed wherein each component has a function which reinforces the other. The components of the bilayer can have equal or different thicknesses within the composite wire. It is known that boron nitride typically has defects which can assist “spintronic” applications enhanced by a magnetic field. Such a field is a consequence of an electric current flowing in the graphene component of the composite wire and immersing the boron nitride component.

### EXAMPLES

In the following examples, temperatures and voltages are measured at the surface of the liquid metal, unless otherwise stated.

Some of the examples involve radical reactions. Radical reactions are best carried out in the absence of the diradical oxygen, for example in a chamber of oxygen-free gas, or under a blanket of carbon dioxide.

### Section A. Electrochemical Syntheses (Electrolysis, Anodic Synthesis, Anodic Decarboxylation, Electrolytic Condensation)

### Example A1. A Carbocyclic 2D Sheet with Pores (Porous Graphane)

The liquid metal surface is cleaned. An unresolved mixture of cis and trans isomers of cyclohexane-1,3,5-tricarboxylic acid as its potassium salt in aqueous ethanol undergoes anodic synthesis on a cleaned, fresh liquid metal surface by applying a positive voltage to the surface. The surface voltage is raised slowly until deposition starts.

The progress of the anodic synthesis is tracked by changes at the surface in the Raman spectrum.

The surface electric potential is raised slowly at all positive voltages up to +40 V or higher to enable anodic oxidation of successive layers in any stack, if needed. Ultrasonics along the surface are used throughout and a wetting agent when needed.

A compression bar is used throughout until the film area no longer contracts with further, small increases in compressive force.

In this Example, a graphane having hydrogen atoms on both sides of the plane of carbon atoms is obtained.

Many variations of this example method are possible. With all hydrocarbons, each H atom can be generalised as R and taken to include ether groups, ester groups and nitrile substituents, for example. By choosing a specific cis/trans-isomer mixture, a substituted monomer, or a mixture of substituted monomers a range of 2-dimensional polymers may be created. Suitable substituents include —OH, —O—R, —ONO, —NO₂, —CN, >CO, —CHO, —COOH, —C≡C—, >C═C<, Br, Cl, F.

Different substituents will create different size pores. Porous graphane may be useful for, for example, filtration and particularly for water desalination.

### Example A2. Fluorinated Graphane

Unresolved isomers of cyclohexane-1,3,5-tricarboxylic acids are fully fluorinated to their perfluoro isomers including three fluoro acyl groups as described in U.S. Pat. No. 2,593,737. The fluoro acyl groups are hydrolysed to their potassium salt by stirring in warm aqueous KHCO₃ or K₂CO₃ and product is recovered by standard processes.

The perfluorinated cyclohexane-1,3,5-tricarboxylate salt, recovered in an unresolved cis/trans isomeric mixture, is dissolved in aqueous ethanol containing KOH. The solution is sprayed onto liquid metal. Ultrasound and/or a wetting agent may be used as appropriate, depending upon the nature of the liquid metal.

Anodic synthesis is then performed as described in Example A1, producing a 2D sheet which is fluorinated both above and below the plane of the cyclohexyl rings. This product, which may be referred to as “perfluorinated graphane” or “poly(perfluorinated cyclohexane)”, has unusually high electrical resistance both in and across the horizontal plane as a monolayer or as a stack.

The process of this example may be varied to allow the synthesis of other substituted graphanes. Monomers comprising cyclohexane rings with three peripheral carboxylic acid groups and having the general formula C₆R₉(COOH)₃ may be used. The carboxylic acid groups may be at the 1, 3, and 5 positions or at the 2, 4 and 6 positions. The R groups may be independently selected and may variously represent hydrogen, an ether group, nitrile, halogen, nitro (—NO₂), nitrite (—ONO), sulfonate or a mixture of any or all of these. Such molecules exist in cis/trans isomers which can be resolved. The process of this example is applicable to unresolved isomers of cyclohexane tricarboxylic acid derivatives.

### Example A3. Perfluorinated Graphane Stacks

The high electrical resistance of the poly(perfluorinated cyclohexane) can be further enhanced by forming a dielectric stack of two or more layers of the poly(perfluorinated cyclohexane). A stack may be formed, for example, using a dipping plate as described with reference to FIG. 4. The stack may be used as an insulating backplane for a thin film transistor (TFT).

### Example A4. Low Temperature Synthesis of Net-Poly(2,4,6-Tricyanobenzene)

High quality ultra-large area graphene would be useful in many industries and for many purposes. For example, graphene may be used to provide shielding from electromagnetic radiation in “stealth” aeroplanes and in wind turbines. Recently it has been reported that graphene can be applied to photovoltaic devices, either during their manufacture or as a subsequently-applied coating, to reduce reflection of light from such devices.

### Step 1: Synthesis of 2,4,6-tribromo-1,3,5-trimethylbenzene

Mesitylene (i.e., 1,3,5-trimethylbenzene) is brominated in total darkness in a black glass container using a moistened solution of bromine and hydrobromic acid in tetrachloromethane for up to 24 hours at RTP. The exact length of time of the bromination is not critical. A few drops of iso-amyl nitrite are added to the bromination mixture to suppress bromination of the methyl groups. At completion 2,4,6-tribromo-1,3,5-trimethylbenzene is the primary product.

### Step 2: Synthesis of 2,4,6-tricyano-benzene-1,3,5-tricarboxylic Acid

Displacement of bromine atoms with nitrile using potassium cyanide in ethanol, with warming maintained at approx. 70° C., followed by oxidation of all the methyl groups to carboxylic acid using cold alkaline aqueous KMnO₄ leading to 2,4,6-tricyano-benzene-1,3,5-tricarboxylic acid.

### Step 3: Preparation a Liquid Metal Surface

Liquid metal is placed in the bath of a system of the type described with reference to FIG. 3. Mercury is favoured here as it resists alkaline media.

The liquid metal surface is cleaned. The intermediate from Step 2, dissolved in a minimum of aqueous ethanol, is then sprayed as its potassium salt onto the mercury in the trough. Ultrasound accompanied by gentle surface compression using the barrier device is employed until the surface resistance starts to rise sharply, when further compression is halted.

### Step 4: Anodic Synthesis of Net Poly(2,4,6-tricyano Benzene) (Electrolytic Condensation of 2,4,6-tricyano-benzene-1,3,5-tricarboxylic Acid)

A mask for controlling the shape of the 2D sheet is laid upon the liquid metal surface if desired.

An electrical potential is applied to the upper surface of the mercury. Polymerization of the 2,4,6-tricyano-benzene-1,3,5-tricarboxylic acid occurs by electrolytic condensation (anodic oxidation). Bonds between monomer units are formed by elimination of the carboxylic acid groups at the 1, 3, and 5 positions. This results in a 2-dimensional polymer comprising a network of benzene rings. Each ring in the network has nitrile groups at the 2, 4, and 6 positions, with the 1, 3 and 5 positions being bound to neighbouring rings.

The exact upper surface voltage at which anodic decarboxylation commences depends upon the electric circuit details, and the size, layout, surface purity and temperature of the mercury substrate. The progress of the anodic decarboxylation may be monitored using a Raman spectrometer. The upper surface reflectivity becomes stable under illumination from the Raman spectrometer when the anodic decarboxylation has completed.

To produce a stack of two or more layers, the electric potential of the upper mercury surface may be held positive and increased slowly towards +40 V or higher to enable anodic oxidation of successive layers in the stack. At the same time, the temperature at the surface can be raised slowly to approx. 60° C.

The polymer surface is dried in air by warming to approx. 60° C., and is washed with aqueous ethanol to remove K⁺ ions and any small molecules and small ions.

This process produces a 2-dimensional network of 2,4,6-tricyanobenzene units. Each unit is connected to three other units, at the 1,3 and 5 positions of the benzene ring. In other words, the product has a porous graphene-like structure, with nitrile substituents. The product may be referred to as net poly(2,4,6-tri cyanobenzene). A fragment is illustrated below:

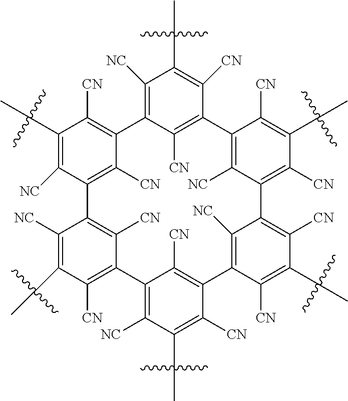 [SMILES: *c1c(C#N)c2c(C#N)c(c1C#N)c1c(C#N)c(*)c(C#N)c(c1C#N)c1c(C#N)c(*)c(C#N)c(c1C#N)c1c(C#N)c(*)c(C#N)c(c1C#N)c1c(C#N)c(*)c(C#N)c(c1C#N)c1c(C#N)c(*)c(C#N)c2c1C#N]

This product has various uses. The product has pores through which Li+ ions can variously pass or be stored. The product is therefore useful as a porous solid for an all-solid battery. Other possible uses include the desalination of salty or brackish water; or as a filter of chemical and biological matter. Applying an electrical potential to the polymer may enhance its filtration properties.

This example provides a cyano-substituted product. It will be appreciated that the described process may readily be adapted to produce structures with other substituents. The size of the pores can be varied by selecting the nature of the substituents.

Alternatives to 2,4,6-tribromo-1,3,5-trimethylbenzene include 1,3,5-triiodo-2,4,6-tri-R substituted benzene, where R is selected from Me, Br, and COOH.

### Example A5. Synthesis of Graphene from Net-Poly(2,4,6-Tri Cyanobenzene)

To convert the product of Example A4 into graphene, the pores are filled with hexagons of carbon atoms. Subsequent steps 5 to 10 illustrate a process for achieving this.

### Step 5: Conversion of Nitrile Groups to Primary Amine Groups

Reduction of the nitrile groups to —CH₂NH₂ (primary amine) is done in the absence of water, water vapour and alcohols after drying using fresh, crushed LiAlH₄ in dry diglyme (bis(2-methoxyethyl ether). After reduction, fragments containing Li and A1 ions are removed in an aqueous solution of 4-hydroxy-5-methyl-3-pyridinecarboxylic acid and are thoroughly washed away.

### Step 6: Oxidation of the Primary Amine Groups to Aldehydes

The primary amine groups are oxidized to alcohol with cold fresh nitrous acid and then oxidised to —CHO (aldehyde) using the method reported by Naimi-Jamal et al in “Sustainable Synthesis of Aldehydes, Ketones or Acids from Neat Alcohols Using Nitrogen Dioxide Gas, and Related Reactions, ChemSusChem 2009, 2, 83-88 (doi: 10.1002/cssc.250800193), in which excess nitrogen dioxide gas is passed slowly over the graphene precursor for some 6 hours. The gases are recirculated, cooled to remove condensate, re-oxidised with clean dry air and recycled over the precursor. Oxidation of alcohol to aldehyde is substantially complete. Further oxidation to carboxylic acid is minimised.

### Step 7: Ring Closure

It is evident that the aldehyde groups have close aldehyde neighbours held in rigid proximity.

These aldehyde groups undergo the aldehyde benzoin condensation in pairs and carbon ring closure takes place under standard conditions which leads to the presence of —CO—CHOH— repeats in the newly formed ring. This removes any pores.

### Step 8: Reduction

Treatment of the —CO—CHOH— groups with fresh NaBH₄ in dry dimethyl formamide creates a diol, which is followed by a warm aqueous methanol wash. After drying in warm air, the diols are converted to ethylenic double bonds in quantitative yield by the method of Corey and Winter “A New, Stereospecific Olefin Synthesis from 1,2-Diols”, J. Am. Chem. Soc. 1963, 85, 17, 2677-2678 (doi.org/10.1021/ja00900a043).

The surface product resting on the liquid metal is held under heated xylene at approx. 120° C. for up to about 60 mins. Xylene vapour is recovered.

Thionocarbamate precursors are administered dropwise or as a mist, keeping the graphene intermediate chemically in excess. A cyclic thionocarbamate forms after which the 1,2 diol groups are transformed completely into ethylenic double bonds by desulfurization and decarboxylation. This is best carried out in a large fume cupboard cooling system or enlarged sealed space to reflux the xylene.

The product is washed clean with aqueous ethanol and dried.

### Step 9: Removal of Remaining Hydroxyl Groups

Isolated hydroxyl groups are largely removed next by irradiation for several hours from a xenon lamp inside an inner reflective housing. The power of the lamp and surface area to be irradiated largely determine the exact time required for complete irradiation.

The vapours and gases are cooled in the fume cupboard cooling system hood, recovered, and recycled. The polymer surface is washed gently with aqueous ethanol to remove chemical by-products which are retained for proper disposal.

Alternatively or additionally, the graphene can be treated with Lawesson's reagent. This replaces adjacent oxygen atoms with ethene bonds to produce an “electronic grade” graphene.

### Step 10: Surface Annealing

The product is surface annealed at 250° C. using an infrared surface heating element for about 60 minutes, in repeated traverses in an oxygen-free atmosphere under slight surface compression and with ultrasonics to promote the formation of larger grain sizes, to reduce grain boundaries and reduce surface stresses in the film. The heating elements in a computer-controlled metal pipe scan the surface above the trough with radiant heat directed towards the surface film.

### Step 11: Additional Surface Annealing

The graphene can be further increased in quality. In the presence of ultrasonic waves and oxygen-free gases, annealing is carried out again at 250° C. for about 60 minutes, using the heating elements in the computer-controlled metal pipe which scans the surface above the trough with radiant heat directed towards the surface film. After cooling to room temperature, a gentle water wash takes any surface ions to the drain where they are recovered. After washing, residual solvent is vapourised.

During the annealing steps, the bulk liquid metal conducts the heat away from the surface. The liquid metal thus acts as a heat sink. Liquid metals typically have high heat capacities, and the bulk temperature of the liquid metal is little changed.

The synthesis of graphene has been presented as an illustrative example. Various modifications may be made to the described process. In one variant, the conversion of the primary nitrile groups to aldehydes is effected by the Stephen aldehyde synthesis using stannous chloride in hydrochloric acid.

### Example A6. Production of Graphene Stacks, Especially Bilayers and Trilayers

The method of Example A5, which produces a monolayer, may be modified to allow the synthesis of stacks of graphene sheets.

Stacks may have different properties to monolayers. For example, bilayer graphene has optical and electrical properties which are different from those of a monolayer. Trilayer graphene has different electrical conductivity and transparency.

For each successive layer on top of the trough, through the mask, a fresh aliquot of a solution of 2,4,6-tricyano-benzene-1,3,5-tricarboxylic acid dissolved in alkaline aqueous ethanol, is sprayed onto the previous layer of graphene in the presence of ultrasonic waves. The aliquot is allowed to settle and is then compressed. Electrolysis is resumed, and the cycle of steps 4 to 13 is repeated until the Raman spectrum changes only with the increased graphene thickness.

After cooling, warm clean air is admitted to remove any hydrogen bound to nascent aromatic rings and to remove any residual fluids including xylene.

These steps produce a film of graphene composed of multiple layers lying on the liquid metal.

### Example A7. Use of a Dipping Plate to Modify the Properties of Graphene Stacks

The magic angle process described with reference to FIG. 2 may be used to produce graphene stacks, e.g. bilayers, with special properties. By transferring a first layer of graphene onto a dipping plate using horizontal film compression, changing the yaw of the dipping plate by a selected angle referred to in the art as a “magic angle”, and then transferring a second layer of graphene onto the first layer by moving the dipping plate, a bilayer structure having interesting properties may be obtained. At a “magic angle”, graphene displays different electrical conductivity. “Magic angles” for bilayer graphene include 0.79, 1.10, 1.59, 2.02, and 3.48 degrees.

In trilayer graphene, special properties may be obtained by twisting the third layer relative to the second layer by an angle of V2 times the magic angle between the first and second layers.

### Example A8. Removing the Product from the Liquid Metal

An “electronic” grade graphene is formed by elimination of residual oxygen.

The graphene product is removed from the surface of the liquid metal. For example, a single atomic layer may adhere to a plate of poly(methyl methacrylate). The single layer is then recovered by dissolving the poly(methyl methacrylate) with acetone.

Alternatively, the surface layer may be recovered by using a slight vacuum because film adhesion to the liquid metal is minimal. For example, graphene layers are removed using the rotating perforated tube under reduced pressure and in contact with the surface located at the end of the mask.

### Example A9. Doping Graphene

The methods described above may be adapted to the production of doped graphene. The dopant may be introduced at any appropriate stage of the methods described in Examples A4 to A9. Doping involves the introduction of deliberate flaws into a graphene surface, for example by replacing some benzenoid rings with a pyridine ring. Doped graphene may be useful in electronics.

Another example dopant is 1,3,5-trioxane-2,4,6-tricarboxylic acid. Other dopants, e.g. those including heteroatoms such as B, N, and/or P, may be used.

### Example A10. Uses of Graphene Sheets

The methods provided herein are useful for producing sheets of graphene which may have surface areas of the order of square meters, referred to herein as ultra-large graphene sheets. Such sheets are chemically and thermally stable at RTP, and are electrically conducting through the sheet, as well as along the sheet. Such sheets also interact with radar and sunlight, as remarked earlier.

Graphene is an electrical conductor and can be used for many purposes in the fields of electronics and electrical engineering, including for electricity transport and distribution. Graphene's high flexibility, high refractive index, high strength and transparency make it suitable for use in optical fibres and optical computing, as remarked earlier.

Ultra-large area graphene sheets can be wound into threads by rotation of a spindle around a horizontal axis. The spindle may then be moved away from the liquid metal surface. For example, a suction bar may be used to remove the graphene from the surface and then rotated around a horizontal axis to wind the graphene. The threads may be formed into fibres, yarns, ropes, and fabric by winding, plaiting, or the like.

Graphene is a better electrical conductor than copper and silver and is stronger than steel. The fibres, yarns and ropes made from graphene are all electrical conductors and are strong.

Threads and fabrics comprising graphene may also be useful in the manufacture of body armour, for example.

Graphene may be applied as a coating on a wide variety of materials. In an example, graphene is deposited by film transfer upon the outer surfaces of a solar panel and thereby energy losses due to reflection of incident energy back into the atmosphere are minimised and output efficiency is raised.

Graphene can be incorporated into flexible panels with other components to create solar cells to be fitted onto the roofs of motor vehicles, trains and other surfaces to retain and use solar energy.

Ultra-large graphene sheets interact with radar signals, and may be applied to vehicles, such as aircraft or watercraft.

Graphene may be incorporated into composite materials. For example, ultra-large graphene sheets may be included in composite materials for covering the blades of wind turbines. Noise absorption has recently been demonstrated in suitably entangled graphene.

Materials may be arranged on the surface of the graphene to provide structures having useful properties. Graphene may be incorporated into a stack comprising layers of various different two-dimensional materials, with some examples being detailed in Section B further below.

Spray coating small graphene particles, or small particles of graphene oxide, onto large graphene sheets can produce brilliant colours thereafter from quantum dots. These are then applied in decorations, pigments, paints, displays and sensors. One embodiment is the consequent production of ultra-large areas of quantum dots.

Intercalation of graphene sheets with carbon nanotubes and/or porous quinoxaline-graphene (later) improves the graphene electrical capacity in batteries and in “supercapacitors” and in their charging and discharging rates.

### Example A11. Graphene Oxide (“GO”)

Once a graphene sheet has been produced, reactions of the graphene may be performed in situ on the surface of the liquid metal substrate. One example process is the production of graphene oxide.

Ozonized air from an ozonizer at atmospheric pressure and at 100° C. is blown over an ultra-large graphene layer on its liquid metal substrate made according to Example A5, for 6 to 10 minutes, accompanied by UV radiation. Chemical oxidation creates carbonyl and epoxide groups on top of the uppermost surface layer, alongside alcohol and carboxylic groups utilizing residual hydrogen atoms on the graphene starting material.

Annealing at 200° C. for 20 minutes under an inert gas removes the hydrogen-containing species.

GO can be utilized as small pieces in solutions of varying strengths, as lubricants and in electronics as a component of an electrode. Ultra-large area GO can be used in sensor technology, energy related and biomedical applications, in batteries and in display screens. It is used in electromagnetism, energy conversion and magnetic media. One particularly preferred use case for GO is its application as an entire, ultra-large sheet in solar panels where its size, transparency and chemical response is unique.

### Example A12. Reduced Graphene Oxide (“RGO”)

GO is reducible in many ways to RGO including continuing UV irradiation in the absence of ozone at 100° C. A further method of GO reduction employs 1,1′-dimethyl hydrazine vapour at 120° C. RGO is useful in energy storage and conversion, and large area RGO will enhance these uses.

### Section B. Formation of Laminate Structures by Reactions on 2D Graphene Sheets

Other reactions to form 2D products and stacks can take place on ultra-large graphene sheets using reagents which would otherwise be liable to react directly with the underlying liquid metal. Examples of such reagents include active components such as boron, phosphorus, sulfur, and/or selenium 2D layers.

Since graphene is chemically unreactive under ambient conditions, but is an electrical conductor, both along and through its plane, other elements too can be formed upon it by electrodeposition, for example.

Many salts can be reduced to their elemental state by electrolysis from a solution in an aprotic fluid. Though there are many examples of deposition from such fluids, none has previously been deployed above an extended flat liquid metal surface at ambient temperatures or upon another conducting surface such as graphene to conduct an electrolysis as in this invention.

Silicon and germanium have unique roles in electronics. Large 2D high quality flexible sheets offer the prospect of the bulk manufacture of electronic components upon a single specimen. Silicon mono-atomic layers form part of the “backpanel” of thin film transistors (“TFTs”) (US 2021/0050385 A1). A large area graphene monolayer lying on a large germanium monolayer has anti-microbial activity.

### Example B1. Deposition of Elemental Silicon

Silicon may be deposited onto a 2D sheet of graphene by electrodeposition from a solution of a silicon salt (e.g., silicon tetrachloride) in an ionic liquid.

One example ionic liquid is 1-butyl-3-methylimidazolium-bistrifluoro-methanesulfonylimide (BMimTf₂N), which is available commercially. Though expensive, it is not much consumed during electrolysis. An alternative ionic solvent is 1-butyl-methylpyrrolidinium bis(trifluoromethylsulfonyl)amide ([Py1,4]Tf₂N).

In an example, BMimTf₂N is dried, subsequently saturated with SiCl₄, and is applied to a graphene sheet arranged on the surface of a liquid metal kept under dry nitrogen. While using ultrasonics, a voltage is applied and is raised steadily towards 40 V or higher to cause electrodeposition of silicon onto the upper surface of the graphene. A Raman spectrometer may be used to detect the formation of a surface layer upon graphene.

After deposition of several Si monolayers upon each other, all upon a graphene base sheet and under an inert gas such as oxygen-free air, repeated sweeps of surface flash infra-red and a flash laser may be used to raise the silicon to an annealing temperature of some 1150° C. and then be allowed to cool to form microcrystalline silicon.

### Example B2. Electrodeposition of Elemental Germanium

The prior art describes many electrolytic depositions of germanium though none onto the upper surface of ultra-large sheets of graphene or liquid metal.

Germanium is present as [GeCl₄(N-butylimidazole)₂] and is deposited from a mixture of 1-butyl-1-methylpyrrolidinium chloride and 1-butyl-1-methyl pyrrolidinium dicyanamide onto liquid metal or graphene made in this invention.

A Raman spectrometer may be used to detect the formation of a surface layer of germanium, as described earlier.

### Example B3. Electrodeposition of Mixtures of Silicon and Germanium

From Examples B1 and B2 it is evident that mixtures of these elements can be deposited together as pure elements, or mixed within a sheet, or to generate stacks with useful semiconductor properties.

Further, when silicon is deposited last in the stack, inversion of the stack leaves silicon at the bottom and electronics on a silicon base are then accessible.

### Example B4. Electrodeposition of Refractory and Other Metals

The electrodeposition of refractory and other metals from aprotic ionic solvents has been reported but not upon the ultra-large graphene sheets described here, nor upon the extended surfaces of liquid metals. These methods can be adapted to allow deposition of metal layers onto graphene sheets.

Examples of metals which can be deposited include: Ti, Zr, Hf, V, Nb, Ta, Cr, Mo, W, Mn, Re, Fe, Ru, Os, Co, Rh, Ir, Ni, Pd, Pt, Cu, Ag and Au.

Since these elements are themselves electrical conductors one may be electrodeposited upon another to make composites and stacks of any combination.

Such stacks can further include graphene, boron nitride, silicon, and silicon oxide (the latter, by dehydration of silicic acids with heat).

Vertical reversal places a silicon or silicon oxide layer at the bottom, if present, and then resembles a familiar semiconductor base.

### Example B5. Use of Heat to Effect Other Changes on Ultra-Large Graphene Sheets

Graphene is stable and is not easily decomposed by heat, particularly when handled in an inert gas atmosphere. The liquid metal acts as a heat sink, allowing a good degree of control over the temperature at its surface. Many thermally-driven reactions can therefore be performed on a graphene sheet.

Examples of atomic rearrangements which lead to deposition of 2-dimensional layers of product at the surface of liquid metal and liquid metal mixtures by heating include reaction of a hydrogen donor with a halogen donor.

### Examples of Hydrogen Donors Include:

LiAlH₄, NaBH₄, PH₄I, NH₄Cl, (Me)₃CNH₂, NH₃BH₃, (Me)₃NBH₃, (Me)₄NBH₄

### Examples of Halogen Donors Include:

Me₂S·BCl₃, BCl₃, PCl₃, POCl₃, PCl₅, AsCl₃, SbCl₃, BiCl₃

### Example B6. Templating Hybrid Organic-Inorganic Perovskites

Graphene is generally and chemically unreactive in air at room temperature and pressure, RTP, so many other chemical changes can be induced upon its surface without damage. Thermal and electrolytic changes are best induced in the absence of oxygen while managing to secure the graphene as actually or largely unchanged.

As it has a hexagonal surface motif, materials deposited upon graphene which are disposed themselves to adopt a hexagonal structure can do so. This is known as “templating”. Templating is possible for many substances, examples of which include hexagonal boron and hexagonal boron nitride, phosphorus, and organic-inorganic Perovskites.

Templating of small specimens of perovskites has been described by P. Kovaricek et al. in “Crystallization of 2-D Hybrid Organic-Inorganic Perovskites Templated by Conductive Substrates”, Advanced Functional Materials, vol. 31, no. 13, 2009007 (doi: 10.1002/adfm.202009007). Larger specimens of such Perovskites would permit direct manufacture of solar panels at full size.

Upon a large sheet of graphene made according to the methods provided herein is laid a hybrid organic-inorganic Perovskite just above the metal substrate melting point with that of the liquid metal or mixture of metals. Upon the freezing of the metal mixture supporting the graphene by cooling, the Perovskite can be pressed down to adopt the hexagonal pattern itself.

### Section C. Synthesis of Inorganic Materials on Liquid Metal Surfaces

This section describes some example syntheses of 2D sheets of inorganic materials. The sheets described here may be synthesised directly on the liquid metal surface, or alternatively on or over a sheet of another material, such as graphene, resting on such a surface.

### Example C1. A Thin Film of Silicon Oxide

Silicic acid, as a solution or suspension, is distributed dropwise or sprayed onto a liquid metal and dehydrated by heating to 180° C. in a current of dry air for 3 hrs. The liquid metal surface accommodates the significant loss of volume of the silicic acid, some 40-45%. Surface compression creates a contiguous surface film of any chosen thickness and flexibility depending upon the amount of silicic acid used. Such films can be a component of display, back panels, flexible or rigid, in thin film transistors.

### Example C2. Formation of Boron Nitride (Method 1)

In a first stage, onto a square trough of side 1-meter containing a 1 cm deep liquid alloy approximating to, or exactly Wood's metal mixture, maintained at 75° C., is sprayed a calculated amount of saturated warm aqueous and alcoholic ammonium chloride, within a mask in the presence of ultrasound, sufficient to form a monolayer. Time is allowed to elapse until all of the water has evaporated.

In the next stage, a calculated mass of the adduct of dimethylsulfide with an equimolar amount of boron trichloride, enough to form a monolayer of boron nitride 1 atom thick, in toluene, is sprayed onto the dry ammonium chloride layer under nitrogen and is heated slowly (over about 1 hour) up to approximately 180° C. and later for one hour at approximately 250° C. A 2D boron nitride sheet is formed:

Me₂S:BCl₃+NH₄Cl→BN+Me₂S↑+4HCl↑

Using ultrasonics, a rectangular array of spray heads, with one set of peristaltic pumps delivering saturated ammonium chloride in warm alcoholic solution and after drying delivering the boron trichloride adduct, using another set of peristaltic pumps, the process continues to cycle through the two stages until a layer of boron nitride of the required thickness is formed under surface film compression.

This cycle of boron nitride synthesis can be automated.

Wires and composite wires of boron nitride and may be drawn in the same way as graphene wires.

### Example C3. Formation of Boron Nitride (Method 2)

In another example process for forming boron nitride, Me₂S:BCl₃ is refluxed with NH₄Cl in toluene in a standard reflux apparatus to form B-tri-chloroborazine, B—Cl₃B₃H₃N₃, according to the prior art, which is then sprayed onto the liquid metal surface and heated slowly over 1 hour to 250° C. under nitrogen or oxygen-free air with film compression. Boron nitride forms. Toluene vapour and hydrogen chloride gas are swept away and recovered where possible.

In both Examples C₂ and C₃, a horizontal rotation of the BN film drawn from one end allows a thread to form. Such threads are known to possess particular electronic properties due to their defects.

The behaviour of the threads can be modulated in a magnetic field.

When boron nitride forms upon graphene and a wire composed of the two layers is jointly drawn off by rotation, this forms a composite wire. The boron nitride carries the defects, but little electricity (being an insulator), while the graphene component carries light to refresh the defects and also electricity, as it is good a conductor, which furnishes the magnetic field to modulate the behaviour of the defects in the other (boron nitride) component.

### Example C4. Composite Stacks

Upon an extended 2D layer of boron nitride produced by the method of Example C2 or C₃ is laid another layer of 2D material by a similar heat deposition process to form a composite structure, or stack.

### Example C5. Formation of a 2D Product of Reacting a Hydrogen Donor with a Halogen Donor

It is evident that, apart from 2D BN, many other 2D outcomes are possible, some entirely novel, such as PP, BP, AsP, and BiSb which can be formed in similar reactions.

Combinations such BB and PP amount to the deposition of 2D layers of elemental boron, dubbed borophene, and phosphorus, sometimes dubbed “phosphorene”.

### Example C6. Deposition of Elemental Boron

An atmosphere of an inert gas such as nitrogen helium, neon, or argon; or clean air with its oxygen removed, is chosen for this synthesis using a square tray of side 1 meter for example.

(Me)₃NBH₃, is commercially available. Previously dissolved in dry diethylether, it is sprayed onto liquid Wood's metal, or a closely similar metal mixture maintained at atmospheric pressure under dry air and is itself allowed to dry for 1 hour with ultrasound. Under a chemically inert atmosphere, Me₂S:BCl₃ dissolved in toluene is sprayed on and the liquid metal mixture surface maintained at 120° C. using radiant heat for one hour. Thereafter the liquid metal surface is maintained at 250° C. using radiant heat for 2 hours under a chemically inert atmosphere.

The product is a 2D layer of boron which has many specialist uses.

Upon this, a layer of boron nitride can be laid as another layer of 2D material by a similar heat deposition process to start to form a composite structure or stack. Boron nitride is also able to protect graphene against surface damage.

### Example C7. Deposition of Elemental Phosphorus

An atmosphere of nitrogen, or clean air with its oxygen removed, or any other chemically inert gas, is chosen for this synthesis using a square tray of side one metre for example.

Phosphonium iodide, known in the prior art and commercially available, in a mixture of dry tetrahydrofuran and diethyl ether, is sprayed onto a 2-D layer of boron nitride itself on a liquid metal mixture of Indium Corporation 60, or a mixture approximating to it, at a temperature close to, but below 25° C.

The surface is allowed to dry for 1 hour, preferably in a current of recirculating gas, after which an equimolar amount of phosphorus trichloride in tetrachloromethane is sprayed onto the surface and the temperature maintained at 50° C. for a further hour.

### A Layer of Phosphorus is Formed:

PH₄I+PCl₃→P monolayer+3HCl↑+HI↑

The phosphorous layer, together with its boron nitride underlayer, is surface annealed at 65° C. with radiant heat for 1 hour and thereafter surface sintered at 75° C. for a further 2 hours both under an inert atmosphere. An allotrope of phosphorus is formed, sometimes dubbed phosphorene.

The product is a 2D layer of phosphorus which has found many specialist uses.

A stack of multiple layers can be formed.

Other two-dimensional materials, such as graphene, may be used as an alternative to the boron nitride underlayer.

### Example C8. Boron Phosphide

Using the same square trough with the same liquid metal mixtures as in Example C7 and on graphene, in a current of inert gas kept below 25° C., PH₄I is reacted with Me₂S·BCl₃ to form boron phosphide:

PH₄I+Me₂S·BCl₃=BP+2Me₂S↑+3HCl↑+HI↑

This layer is surface annealed at 65° C. for 1 hour and thereafter surface heated at 75° C. for a further 2 hours as before.

Boron phosphide has unusual electronic properties. Its outermost d orbital is perpendicular to the plane of the sheet and may interact with d orbitals in the planes above and below.

### Example C9. Stacks of 2D Layers of B, as, Sb and Bi

These 2D monolayers formed individually from (Me)₄NBH₄, for example, and solutions in dry diethyl ether containing AsCl₃, SbCl₃ and BiCl₃ respectively are especially important because the atoms within each layer can have direct chemical bonding and communication between adjacent sheets.

Furthermore, dry mixtures of PCl₃, AsCl₃, SbCl₃ and BiCl₃ can be used to form novel combinations in diethyl ether within the same monolayer.

Another feature of P, As and Bi is that their nuclei are all monoisotopic in nature. When combined with ¹⁰B, or ¹¹B (each individually available commercially), a monoisotopic 2D substance is formed. Such a product offers novel opportunities for especially accurate quantum entanglement, quantum coherence, that is, signalling between nuclei, a requirement for quantum computing and “spintronics” since “noise” levels are low.

### Example C10. Deposition of Elemental Sulfur

Ammonium thiosulfate is commercially available. After spraying an aqueous alcoholic solution onto graphene on a liquid metal and heating, it decomposes:

(NH₄)₂S₂O₃→2NH₃↑+H₂O↑+SO₂↑+S↓

This layer of sulfur is ideal for forming one layer of layered dichalcogenides.

In addition, sulfur layers have a low annealing temperature, and may be annealed by heating the layer to about 90° C. in an oxygen-free gas.

Annealing a sulfur monolayer on graphene may produce sulfurane.

### Example C11. Deposition of Elemental Selenium

There are many ammonium salts of selenium oxy acids which will start to decompose at around 150° C. on graphene on a heated liquid metal. When mixed with powdered oxalic acid, for example, elemental selenium is deposited in this approximate reaction in an inert atmosphere:

2(NH₄)HSe₂O₅+5H₂C₂O₄→N₂↑+10CO₂↑+10H₂O↑+4Se↓

Annealing under surface compression is carried out by repeated near infrared flash surface heating up to 190-250° C. for some 30 minutes in an inert atmosphere, such as nitrogen, at atmospheric pressure. Sheets of selenium atoms form as required in some layered dichalcogenides.

### Example C12. Deposition and Annealing of Copper and Zinc Oxides

Both copper and zinc hydroxides form ammines in aqueous ammonia. These are unstable to heat and readily decompose to their oxides in an amorphous layer under an inert atmosphere. Thin layers of each have uses in electronics:

Cu(NH₃)₄(OH)₂→CuO+H₂O↑+4NH₃↑

Many metal hydroxides, including those of cobalt and chromium, form ammonia-soluble hydroxides which decompose to oxides in a similar manner.

Copper oxide films anneal as a Cu₂O phase at 200° C., while pure CuO films are obtained at annealing temperatures above 300° C., both lying upon a silicon dioxide or boron nitride base themselves lying upon liquid metal.

Zinc oxide (ZnO) thin films are annealed on liquid metals in the temperature range of 250 to 450° C.

### Section D. Synthesis of Porous Quinoxaline-Graphene, its Derivatives, and Laminates Thereof

### Example D1. Formation of “Porous Quinoxaline-Graphene”

“Porous quinoxaline-graphene” refers to a two-dimensional network polymer having a structure as illustrated in FIG. 7. A related three-dimensional polymer is disclosed in GB 2 358 867 B, and is named in that document as “polycyclopyrazine”.

The synthesis of a two-dimensional layer of porous quinoxaline-graphene on the surface of a metal is described for the first time here.

A known number of moles of benzene-1,3,5-triol (“phloroglucinol”) is dissolved in the minimum volume of 50% v/v cold aqueous ethanol, previously saturated with KOH, all at room temperature. To this mixture is added a freshly prepared solution of hydroxylamine hydrochloride itself dissolved in the minimum volume of cold 50% v/v aqueous ethanol with KOH and in the mole ratio of at least 3:1 hydroxylamine:phloroglucinol.

After dropwise addition or spraying of the mixture onto the liquid metal, the surface is raised rapidly to approximately 80° C. using steam or flash infrared and clean warm air is passed over the surface at atmospheric pressure to remove residual hydrogen.

For simplicity the product is dubbed “porous quinoxaline-graphene”.

### Example D2. Derivatives of Porous Quinoxaline-Graphene

Nitrogen in porous quinoxaline-graphene precursors may be replaced by any of Group V (P, As, Sb, Bi) and Group VI (O, S, Se, Te) or any mixture of these, coordinating with the D-block elements as cited earlier.

Lying on a liquid metal surface a potential can be applied up to +40 V or higher to enable anodic oxidation of successive layers in any stack with +40 volts or greater at the surface to create new chemical species and reactions.

This extended delocalised electron structure is disposed to allow “Magic Angles” between successive sheets. This structure promotes the rapid charging and discharging of electrons.

### Example D3. Porous Quinoxaline-Graphene May Coordinate Transition Metals and Transition Metal Ions (M)

Porous quinoxaline-graphene can coordinate a wide range of transition metal ions (M), including D Block Elements Atomic Numbers 22-30, 40-48 and 72-80, or a mixture, as illustrated below:

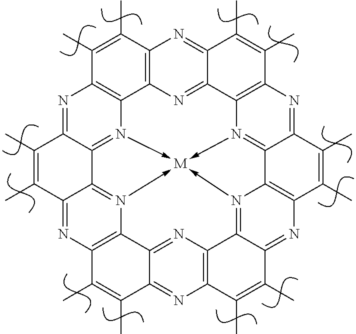

### Example D4. Porous Quinoxaline-Graphene for Nuclear Spintronics

Computing has largely reached the maximum that silicon “chips” can allow. The next generation of computers may use “nuclear spintronics” as this approach allows multiple channels to be used simultaneously and at room temperature.

To allow for communication between nuclei, several criteria should be met. The nuclei should be monoisotopic, to reduce electronic “noise”. The nuclei should be arranged close enough in space to assist “quantum entanglement” and promote spin coherence between adjacent resonating nuclei. The nuclei should have a multiplicity of nuclear spins, each of which can communicate with the same spin in its neighbour to accelerate the transmission of signals and make this computing very fast. The nuclei should be excitable by radio frequency signals.

Providing a highly regular conducting atomic lattice would assist current and magnetic field flows. Ideally, the process could operate under ambient conditions and resist aerial oxidation of the monoisotopic nuclei.

The combination of porous quinoxaline-graphene and cobalt may satisfy these criteria.

Naturally-occurring cobalt is monoisotopic, and consists of the stable isotope ⁵⁹Co. Cobalt is readily available, is magnetic, cheap and has a high nuclear spin multiplicity of 7/2, i.e., enabling communication through 7 channels simultaneously. The porous quinoxaline-graphene provides a highly regular planar lattice having pores with ligand atoms which can form planar complexes with Co in various oxidation states, including zero. The high regularity of the pores and close physical proximity of adjacent pores promotes quantum entanglement and spin coherence.

¹²Carbon (98%) and ¹⁴nitrogen (99%+) in porous quinoxaline-graphene are also themselves near monoisotopic, which keeps “noise” levels low.

A desktop NMR machine which is operable under ambient conditions is available. A quantum sensor which monitors nuclear signals over the entire radio frequency spectrum has recently been made available.

Porous quinoxaline-graphene serves as an electrically conducting regular 2D crystal which binds metal ions within its pores and allows the nuclear quanta emitted after radio frequency excitation to be transmitted to other nuclei and recorded by a quantum sensor. A “spintronic” device based on porous quinoxaline-graphene and cobalt may serve as a quantum computer operable at room temperature, and may lend itself to miniaturisation and mass production.

### Example D5. Alkylation and Especially Methylation of Porous Quinoxaline-Graphene

“Porous quinoxaline-graphene” can undergo N-alkylation by standard processes using standard alkylating agents such as dimethyl sulfate. In this polymer there are 6 basic nitrogen atoms in each pore of which an average of only approximately three react with methyl sulfate due to steric hindrance. Methylation accordingly results in a mixture of N-methyl-pyrazinium and N,N′-dimethyl-pyrazinium ions.

This process forms a highly charged polymer. The polymer can act as an anode in a secondary cell where its half-cell potential is approximately −1 to −1.5 volts, depending on the electrochemical cell being used. In accordance with another possibility, the polymer can act as one plate in a capacitor.

### Example D6. Printing Inks

Porous quinoxaline-graphene and any of its complexes with metal ions, stacks with graphene, as well as attached phosphorescent and fluorescent species may be included in printing inks. Such inks may act as electrical conductors in printed circuitry in electronics, in electrically chargeable wearable fabrics and in protective garments to safely discharge static electricity.

### Example D7. Coatings for Photovoltaic Cells

Photovoltaic cells, also called solar cells, suffer from several deficiencies which limit the efficiency with which they convert light into electricity. Reflection of incident light from the upper (outer) surface of the panel results in a loss of energy input. In dry conditions, dust is easily deposited on the upper (outer) surface of the panel, and this reduces the absorption of incident light. Materials produced in accordance with the present methods may be used to improve the efficiency of photovoltaic cells.

Reflection losses of radiation away from the solar panel may be reduced by coating the upper (outer) surface with large area graphene and/or porous quinoxaline-graphene, for example. Such a coating would ideally cover the whole upper surface with one large contiguous layer.

Dust from storms and winds generally carries a net negative electrostatic charge due to the friction of larger particles with the smaller ones which settle on the upper faces of the solar cell. The layer of smaller charged particles is reduced by imparting the upper layer of the solar cell with its own negative charge so as to repel incoming small dust particles.

A negative charge may be imparted to the surface by inclusion of a polymerised quinone component in the surface film as this will be oxidised to a quinol structure (having a negative surface charge) formed by aerial oxidation and incident UV light.

Another suitable surface layer is that of methoxy poly benzo quinol given a negative charge by removal of its hydroxy protons.

### Section E. Further Polymers

### Example E1. Synthesis of a Polymerised Quinone

Quinone has a rare and important property. It is a component of the well-known quinol-quinone redox pair and can both accept electrons, and return them, in a stable cycle acting as the cathode in a battery and in a capacitor. The quinone-quinol equilibrium, which can be used as part of the cathode charging and discharging cycle, is illustrated below:

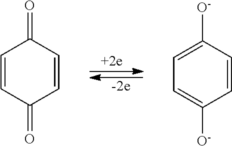 [SMILES: O=C1C=CC(=O)C=C1 ; [O-]c1ccc([O-])cc1]

This is a redox equilibrium which can be paired with that of porous quinoxaline-graphene.

It is stable to repeated rapid charge-discharge cycles, and, further, as a polymer will withstand reasonable physical shocks.

The surface of liquid mercury is cleaned by sweeping the surface, together with filtration, e.g., over and through porous polymer and containing precipitated sulfur if necessary.

2-methoxy-1,4-benzoquinone, available commercially, dissolved in a minimal volume of ethanol is sprayed upon a substrate of cooled liquid mercury as a monolayer under oxygen-free air at 23° C. An aqueous KOH: 2-methoxy-1,4-benzoquinone mixture with sufficient KOH to form an overall mole ratio of 1:1 is sprayed with cooling onto the benzoquinone in air.

Moist air is recirculated over the reactants for 5 hours and, after cooling, concentrated cold aqueous HCl is added to the polymer. After washing free of Cl—, followed by a 20 volume H₂O₂ wash to remove residual hydroxy groups, the product may be air dried at 105° C. for 6 hours.

### The Polymer Structure Approximates to:

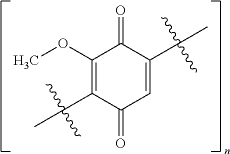

which has been dubbed methoxy poly 1,4-benzoquinone. This is a conjugated polymer in a flat sheet and therefore it is an electrical conductor. Other layers can be stacked upon it.

This is an example of an organic cathode. It is chemically and physically robust while it charges and discharges electricity rapidly.

### Example E2. A Quinonoid High Molecular Weight Flat Molecule

1,4-benzene-dimethoxy ether is commercially available and is treated with two moles of bromine in dichloromethane (CH₂Cl₂) per mole of ether. On standing for several hours (the exact time is not important) at RT a main dibromo isomer is 1,4-dimethoxy-2,5 dibromobenzene.

This benzenoid compound is refluxed for several hours (the exact time is unimportant) with sodium acetylide slurry in xylene (available commercially) under dry nitrogen. An average of 2 acetylide moieties, —C≡CH, is typically attached to the benzene ring at positions 2 and 5. Sodium bromide settles out and after cooling is filtered off in a standard Büchner Funnel under reduced pressure.

Using the method of Li Zuo et al. “an efficient method for demethylation of aryl methyl ethers”, Tetrahedron Letters, Volume 49, Issue 25, 16 Jun. 2008, Pages 4054-4056 (doi: 10.1016/j.tetlet.2008.04.070), demethylation of the intermediate is completed with a ratio of at least 5 moles of iodocyclohexane (commercially available) to 1 mole of intermediate refluxed together in DMF (dimethylformamide) for 14 hours under dry nitrogen. Yields of demethylated product as 1,4 diols are typically over 90%.

Iodine and iodocyclohexane are recovered for reuse.

The diols, lying upon mercury, are oxidised to 1,4 quinonoid ketones using the method of Gogoi and Konwar. The reaction system comprises iodine, potassium iodide (25 mole %), potassium carbonate, in water at 90° C. for several hours. A slow iodination of the alkyne groups may start alongside the polymerisation. Linking and cross-linking follow upon UV irradiation.

### Example E3. Synthesis of Net Poly(Benzoquinone), Useful as a Cathode

2,4,6-triiodobenzene-1,3,5-tricarboxylic acid is available commercially. It is treated with cold thionyl chloride in DMF to form the tri acyl chloride and then treated with sodium iodide in dry acetonitrile to form the tri acyl iodide. This leaves 2,4,6-triiodobenzene-1,3,5-triacyl iodide which is sprayed onto the liquid metal. Excess acetonitrile is removed with a wash of pentane or 2-methyl butane and is recovered or disposed of according to the local regulations.

An intense Xenon source then irradiates the surface for some 30 minutes. Iodine above its sublimation temperature (113° C.) is driven from its several bonds and carried away in oxygen-free air and is recovered for reuse.

Without wishing to be bound by theory, it is believed that this reaction proceeds via the intermediate illustrated below:

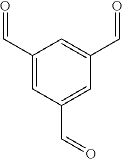 [SMILES: O=Cc1cc(C=O)cc(C=O)c1]

Under surface compression, ultrasonic waves and heating to 80° C. this forms net poly(benzoquinone): a porous 2D sheet made up of a plurality of polycyclobenzoquinone units. One polycyclobenzoquinone unit is illustrated in the formula below:

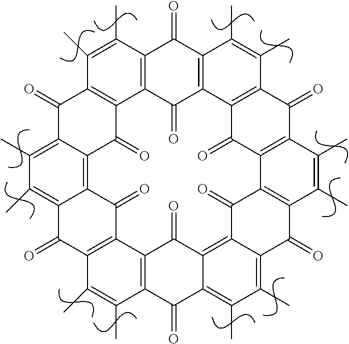

The polymer has an extended delocalised electron structure which is disposed to allow “Magic Angles” between successive sheets.

The planar structure of the polymer promotes the rapid charging and discharging of electrons, an important feature which fits the polymer for use in electric or hybrid vehicles, particularly those with regenerative braking systems where intermittent braking requires the rapid conversion of kinetic energy into stored electrons to help maximise the efficiency of motion.

### Example E4. A Further Cathode Synthesis

An electron acceptor (cathode) is formed from 2,4,6-tribromobenzene-1,3,5-tricarboxylic acid.

The 2,4,6-tribromobenzene-1,3,5-tricarboxylic acid is polymerised by anodic decarboxylation on a graphene sheet lying on liquid Woods Metal. Bromine is displaced by —OH from ethanolic KOH solution, followed by oxidation with 30 volume of aqueous H₂O₂, the product being dried at a temperature above 100° C.

These stages may be repeated to form a stack.

### Example E5. Synthesis of Polycyclo-s-Triazine

A further example of a conductive polymer is net poly(s-triazine) (also referred to as “polycyclo-s-triazine”), a porous polymer comprising units as illustrated in the formula below:

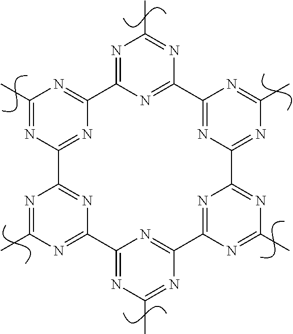

This is synthesised from commercially available sym-triazine-2,4,6-tricarboxylic acid. As its metal salt, for example, the potassium salt in an alkaline aqueous ethanolic solution, it is sprayed onto the surface of a liquid metal as in earlier examples. Anodic decarboxylation occurs as the voltage is raised slowly towards +40 V and this may be detected using Raman Spectroscopy.

This polymer can bind Co, e.g., from tricarbonyl cobalt nitrosyl and dicobalt species, in a flat square planar complex where the metal species is in a highly regular environment that lends itself to spin coherence and spin entanglement in room temperature nuclear spintronics.

As will be explained further below, polycyclo-s-triazine is also useful as an anode for an energy storage device.

### Example E6. Graphdiynes

Graphdiynes are another class of polymer which may be produced by the methods provided herein. Graphdiynes may be synthesised from monomers which are ethynyl benzene derivatives. For example, alkyne groups of neighbouring monomers can be coupled together by the Glaser-Hay reaction.

One example monomer is 2,4,6-s-triazine-1,3,5-triethyne:

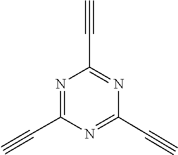

which can form a contiguous 2D sheet with very large pores and an extended electronic conjugation after the terminal ethynyl H atoms are removed on the surface of liquid metals using the Cu (I) catalyst of the Glaser-Hay method followed by polymerisation on a liquid metal substrate.

Quantitative conversion occurs when a terminal ethyne group is coupled with another in the presence of CuI, I₂ and a solid base of Na₂CO₃ in DMF at 80° C., with 99% conversion. The structure of the resulting product is illustrated below:

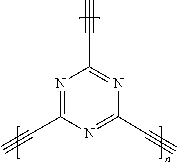

The pore size of this 2D compound is so large that metal clusters and mixed metal clusters can be accommodated within it. They are tethered to the N ligands, or other ligand atoms from Group V while lying on liquid metal, graphene or boron nitride. For example, U and Th carbonyl complexes and simultaneously Pt and Pd carbonyl complexes will bind to each other in mixed metal carbonyl clusters and to N and other ligand atoms.

By raising the electric potential towards +40 V or higher, under an inert gas, if necessary, new chemical transformations can be induced especially with gases as this approach to chemical transformations is novel.

Using the apparatus described herein, after the Glaser-Hay reaction, the polymer surface is washed with aqueous ethanol until all the reagents and by-products have been removed.

Irradiation with UV and VUV lamps produces cross-linking within and between layers and forms a rigid, robust 3D polymer.

### Section F. Energy Storage Devices

### Example F1. Electricity Storage and Capacitors

The methods described herein are useful for the manufacture of energy storage devices such as batteries and capacitors. These devices can be made in whole or in part using the methods of the present invention. The electricity storage device contains a positive electrode (anode), exemplified by porous quinoxaline-graphene, and a negative (cathode), exemplified by net poly(benzoquinone) (“polycyclobenzoquinone”). One or both of the anode and cathode may be produced in accordance with the methods provided herein.

In an energy storage device, the anode and cathode are typically separated by a dielectric layer. The dielectric layer may comprise a dielectric material produced in accordance with a method as described herein, for example boron nitride or perfluorinated polycyclohexane. Other dielectric materials may be used.

Intimate contact of the dielectric layer with the electrodes may be improved with a few drops of ethylene carbonate or propylene carbonate mixed with a smaller quantity of dimethoxyethane or a similar fluid.

In the energy storage devices, electrons may intercalate between 2D layers of atoms. During the charging and discharging of such devices, the only movement is that of the electrons. There is no motion of molecules, atoms or ions moving between electrodes. The cell is capable of charging and discharging very rapidly.

These properties are particularly useful in the context of hybrid or electric vehicles. When a vehicle slows, its kinetic energy can be converted into electricity by a regenerative braking system. The electricity is generated in a relatively short burst. A battery which can charge rapidly can store more of that energy. This raises the energy efficiency of the vehicle and may allow an increase in the range of the vehicle from a single battery charge.

Rapid discharge is useful for allowing an electric motor to generate a high torque. High torque is necessary to move heavy vehicles such as lorries, buses, and trains, and can be desirable for lighter vehicles.

Contrary to some previously claimed examples elsewhere, this is truly an “all polymer battery” and contains no metal species whatsoever.

No lithium, and indeed no metals at all, are required in this design. The environmental costs associated with metal extraction are avoided. There are no waste metal compounds to pollute the environment and waterways after the batteries' useful lives end. Metallic wastes do not form; waste disposal costs and any need for recycling of metal wastes are minimised.

### Example F2. Charge-Discharge Cycle of an Example all-Polymer Battery

Uncharged anode porous quinoxaline-graphene and the uncharged cathode polycyclobenzoquinone offer and accept electrons respectively upon charging. Upon discharge these roles are reversed.

Two equilibria used as the anode and cathode charging and discharging cycle are illustrated below:

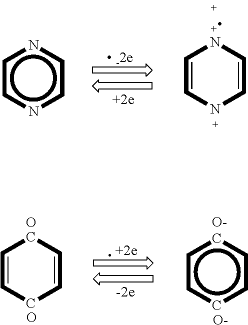

A pair of these electrodes, with a dielectric layer, constitutes a battery cell and can form a capacitor pair of plates. This electricity storage device has no moving ions, atoms or molecules, and contains no metal species whatsoever. Only electrons move and are accommodated by the rearrangement of the “aromatic” electrons.

This allows the device to charge, discharge and recharge as rapidly as possible. It is a hybrid device since it combines the properties of a battery and a capacitor. It rearranges its electrons to variously receive and discharge electrons and can also store electrons by intercalation between its 2D flat sheets.

This is the only true “All Polymer Battery”, APB, so far reported.

Since all its constituent atoms, B C N O, are from the second period of the Periodic Table it will have a high-power density compared to other batteries, e.g., containing sodium, potassium, or sulfur.

It is solid in its construction, has no liquid electrolyte and its delocalised bonding in both electrodes confers upon it a robust and rugged strength. It is scalable to any practicable size or shape. It contains no metallic species whatsoever in its functioning parts, though the inclusion of metals in passive components such as an outer casing is not excluded.

### Example F3. Electricity Storage: A Capacitor and a Battery

An example battery comprises a layer of porous quinoxaline-graphene in contact with a solid dielectric itself in contact with a layer of polycyclobenzoquinone or methoxy poly 1,4-benzoquinone or both.

This three-layered stack can be rolled up into a cylindrical shape. The stack can be formed as a larger stack as required to store greater charge, i.e., the design is scalable and can contain multiple repeats.

The layers are staggered along the axis of winding so that the two electrodes can be in contact with their individual electrical terminals.

These terminals are protected from inadvertent simultaneous contact to prevent an unintended discharge.

### Example F4. Energy Storage Device Having a Polycyclo-s-Triazine Anode

Net poly(s-triazine), a polymer made up of a network of polycyclo s-triazine units, is useful as an anode of an energy storage device as described herein. This polymer will release electrons at a positive potential, several per ring up to a likely maximum of 3. There is no movement of molecules, atoms or ions between anode and cathode. Charging and discharging of electricity is very rapid.

Each hexagon encapsulates an “aromatic” ring. As multiple layers, polycyclo-s-triazine can act as another anode and it is lighter per electron transferred than is porous quinoxaline-graphene.

A thin dielectric can separate the anode, porous quinoxaline-graphene, and cathode, polycyclobenzoquinone, electrodes, made of multilayer boron nitride or perfluoro-polycyclohexane, for example. Other dielectrics may be used.

### Section G. Polynucleotide Sheets

### Example G1. Polynucleotides and DNA in Flat Sheets

Double stranded linear DNA and RNA have paired anti-parallel strands. A saturated aqueous solution of double stranded DNA and an aqueous solution of formaldehyde are sprayed upon the liquid metal surface as described herein, held at or near +6 V and at RTP to form a monolayer where neighbouring strands are now chemically linked after standing with formaldehyde or glyoxal (ethanedial). As the sodium salt, 0.28 mg of dry calf thymus DNA in saline solution are sprayed onto the surface per square meter of exposed metal surface. This amount of DNA will form a monolayer.

Before drying, the aqueous solution of formaldehyde sprayed onto the DNA layer is raised in temperature slowly to 100° C. over 60 mins. under an inert gas, ideally nitrogen, while keeping the surface electric potential at or near +6 V.

After cooling, a water wash is used to remove excess formaldehyde or glyoxal and the surface polymer is dried in an air current when cool.

The product is a cross-linked polymer sheet of DNA. A similar process can be used with double stranded RNA, copy-DNA (c-DNA) and oligonucleotides. Double stranded poly nucleotide chains, that is, having a sequence chosen by a person skilled in the art can be used in a similar way to DNA whether the nucleotides are in the notional B form or Z form or are mixed along the base sequence.

The polynucleotide base sequence may be chosen to be complementary to any other sequence such as that of a virus, bacterium, or other nucleotide base series.

In this process advantage is taken of the structure of any double stranded DNA, RNA and polynucleotides. Both the B and Z forms have a similar structure, established in “Nucleic Acid Different Approach” (Crystallography A https://www.researchgate.net/publication/334883986_NUCLEIC_ACID_CRYSTALLOGRAPHY_-_A_DIFFERENT_APPROACH/link/5d440c4a92851cd04699ec40/download).

Sheets of cross-linked nucleic acids formed by warming with formaldehyde or glyoxal (ethane 1,2 dial) at +6 V surface potential have embodiments as sensors, medical diagnostic tools and detectors of bacteria, viruses and other double stranded nucleic acids of complementary sequence.

### Example G2. Mixtures of Single Wall Carbon Nanotubes

An oligonucleotide may in particular have a sequence to select preferentially certain single wall nanotubes from mixtures. Such sequences have been reported in the art.

### To Date it has Proved Difficult to:

a) separate single wall carbon nanotubes into different lengths, and
b) separate left- and right-handed nanotube isomers.

An oligonucleotide alternating purine-pyrimidine base sequence, especially (dC.dG)ₙ, of pre-chosen length is selected and treated with bromine, a process described in the prior art. It is known in the art that this fixes the sequence in the Hoogsteen configuration.

In stage 1, using the liquid metals in this invention the sequence from an aqueous medium is laid upon the liquid metal at +6 V and allowed to equilibrate with a raw mixture of carbon nanotubes.

Thereafter, the remaining solution is recovered after washing and retained for further separations on a second liquid metal at +6 V using a different oligonucleotide alternating purine-pyrimidine base sequence.

In stage 2, the carbon nanotubes held on liquid metal in stage 1 are removed by a saline wash containing urea, and retained.

Proceeding stage-wise to separate mixtures of carbon nanotubes, specimens of required purity can be generated and retained.

In a refinement of this process, a chiral benzenoid moiety is appended to the oligonucleotides to resolve chiral single wall carbon nanotubes (“SWCNTs”). Chromophores can be appended to monitor the progress of binding SWCNTs.

The process can be extended to multiple wall carbon nanotubes (MWCNTs). Such mixtures can be separated by similar steps using their outermost carbon layer.

It will be appreciated that the above embodiments have been described by way of example only. More generally, the disclosure provides the following Clauses:

Clause 1. A method of synthesizing a layer of two-dimensional material or a stack of layers of two-dimensional material, which method comprises:
providing a liquid precursor composition on a flat surface of a liquid metal, the liquid metal being a metal or metal alloy having a melting point of less than or equal to 250° C. at a pressure of 1 atm; and
forming at least one layer of two-dimensional material on the surface of the liquid metal from the liquid precursor composition, preferably in an oxygen-free atmosphere or under carbon dioxide.

Clause 2. The method according to Clause 1, further comprising using a movable barrier to form and/or compress a thin layer of the liquid precursor composition, the thin layer having a thickness in the range 1 to about 10 monolayers.

Clause 3. The method according to Clause 2, wherein the movable barrier is used to form a thin film of the liquid precursor composition before forming the at least one layer of two-dimensional material.

Clause 4. The method according to Clause 2 or Clause 3, wherein the movable barrier is used to compress the thin film during the formation of the at least one layer of two-dimensional material.

Clause 5. The method according to any preceding Clause, wherein a mask is present on the surface of the liquid metal, the mask being configured to control a shape of the two-dimensional material.

Clause 6. The method according to any preceding Clause, wherein forming the at least one layer of two-dimensional material on the surface of the liquid metal comprises performing a reaction of the liquid metal precursor composition.

Clause 7. The method according to any preceding Clause, wherein the reaction comprises an electrochemical process, the electrochemical process including passing a current through the liquid precursor composition.

Clause 8. The method according to Clause 7, wherein the electrochemical process comprises electrolytic condensation.

Clause 9. The method according to Clause 7, wherein the electrochemical process comprises electrodeposition.

Clause 10. The method according to Clause 9, wherein the electrodeposition is electrodeposition from an aprotic solvent.

Clause 11. The method according to any preceding Clause, wherein forming the at least one layer of two-dimensional material includes surface heating of the liquid precursor composition.

Clause 12. The method according to any preceding Clause, wherein forming the at least one layer of two-dimensional material includes exposing the liquid precursor composition to radiation.

Clause 13. The method according to Clause 12, wherein the radiation is electromagnetic radiation, optionally ultraviolet radiation.

Clause 14. The method according to any preceding Clause, wherein the layer or stack of layers comprises a layer of a material selected from: borophene, silicene, phosphorene, germanene, arsenane, antimonene, bismuthane, selenane, sulfurane, boron nitride, boron phosphide, silicon-germanium.

Clause 15. The method according to any preceding Clause, wherein the layer or stack of layers comprises a layer of a metal selected from Ti, Zr, Hf, V, Nb, Ta, Cr, Mo, W, Mn, Re, Fe, Ru, Os, Co, Rh, Ir, Ni, Pd, Pt, Cu, Ag and Au.

Clause 15A. The method according to any preceding Clause, wherein the layer or stack of layers comprises a layer of a metal selected from Th and U.

Clause 16. The method according to any preceding Clause, further comprising conditioning the layer or stack on the surface of the liquid metal.

Clause 17. The method according to Clause 16, wherein the conditioning comprises annealing the layer or stack.

Clause 18. The method according to Clause 17, wherein the annealing is laser annealing.

Clause 19. The method according to any of Clauses 16 to 18, wherein the conditioning comprises compressing the layer or stack using a movable barrier.

Clause 20. The method according to any of Clauses 13 to 19, wherein the conditioning comprises sonicating the layer or stack.

Clause 21. The method according to any preceding Clause, which is to synthesize a stack comprising at least two layers of two-dimensional material.

Clause 22. The method according to Clause 21, wherein the stack is a composite stack comprising two or more different two-dimensional materials.

Clause 23. The method according to Clause 21 or Clause 22, comprising synthesizing one or more layers of electrically conductive two-dimensional material on the surface of the liquid metal; and subsequently synthesizing one or more further layers of a two-dimensional material on the one or more layers of electrically conductive two-dimensional material by an electrochemical reaction.

Clause 24. The method according to any of Clauses 21 to 23, further comprising intercalating carbon nanotubes between layers of two-dimensional material in the stack.

Clause 25. The method according to any preceding Clause, further comprising transferring the layer or stack onto a dipping plate.

Clause 26. The method according to Clause 25, comprising:
performing a first synthesis to form at least one first layer of two-dimensional material on the surface of the liquid metal;
transferring the at least one first layer onto a dipping plate;
performing a second synthesis to form at least one further layer of two-dimensional material on the surface of the liquid metal; and
transferring the at least one further layer onto the at least one first layer, thereby forming a stack.

Clause 26A. The method according to Clause 26, wherein the method further comprises: after transferring the at least one first layer and before transferring the at least one second layer, changing a yaw of the dipping plate.

Clause 27. The method according to Clause 26 or Clause 26A, wherein the at least one first layer and the at least one second layer comprise the same material.

Clause 28. The method according to any of Clauses 25 to 27, wherein the dipping plate comprises two sheets arranged in a sandwich structure, and wherein the method comprises, after forming the stack, removing the stack from the dipping plate by folding open the sandwich structure and dissolving the sheets in a solvent.

Clause 29. The method according to any of Clauses 1 to 24, further comprising removing the layer or stack of layers of two-dimensional material from the surface of the liquid metal by suction.

Clause 30. The method according to any preceding Clause, wherein the liquid metal is mercury or Wood's metal.

Clause 31. The method according to any preceding Clause, wherein the layer or stack of layers of two-dimensional material comprises a layer of a two-dimensional polymer.

Clause 32. The method according to Clause 31, wherein the two-dimensional polymer is a conductive two-dimensional organic polymer.

Clause 32A. The method according to clause 31 or clause 32, wherein the two-dimensional polymer coordinates to a metal or metal ion selected from: beryllium, sodium, aluminium, scandium, manganese, cobalt, yttrium, niobium, rhodium, caesium, praseodymium, terbium, holmium, thulium, gold, bismuth and thorium.

Clause 33. The method according to any preceding Clause, wherein the two-dimensional material is, or the stack comprises one or more layers of, a porous network polymer comprising units according to formula:

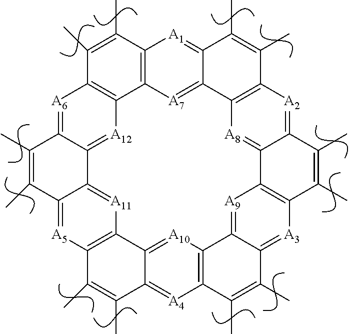

wherein:
A1 to A12 are each independently selected from CH, CR4, N, NR5, P, As, Sb, Bi, O, S, Se, and Te;
each R4 is independently selected from a halogen, a carbonyl oxygen, alkyl groups, alkyl ethers, alkyl esters, nitrile, nitro, nitrite, or sulfonate;
each R5 is independently selected from C1 to C3 alkyl groups.

Clause 34. The method according to Clause 33, wherein A1 to A12 are each N.

Clause 35. The method according to Clause 33, wherein A1 to A12 are each CH.

Clause 36. The method according to any preceding Clause, wherein the two-dimensional material is, or the stack comprises one or more layers of, a porous network polymer comprising units according to formula:

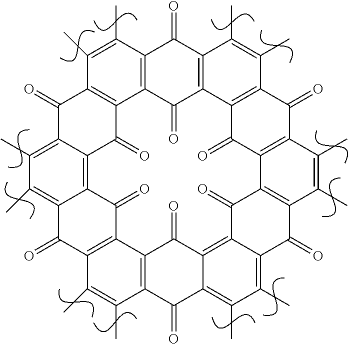

Clause 37. The method according to any preceding Clause, wherein the two-dimensional material is, or the stack comprises one or more layers of, a porous network polymer comprising units according to formula:

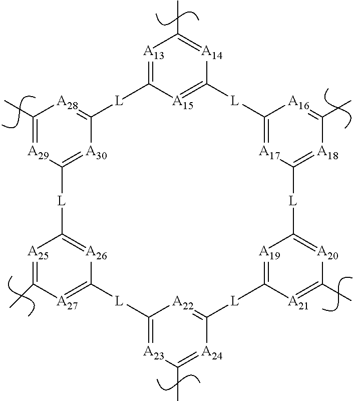

wherein:
each L is a linker selected from a bond, —C≡C—, —C≡C—C≡C—, O, and S;
A13 to A30 are each independently selected from CR6, N, N-alkyl, P, As, Sb; and
each R₆ is independently selected from H, halogens, alkyl groups, alkyl ethers, alkyl esters, nitrile groups, nitro groups, nitrite groups, sulfonate groups, and —CHO.

Clause 38. The method according to Clause 37, wherein each L is —C≡C—.

Clause 38A. The method according to Clause 37 or Clause 38, wherein each of A13 to A30 is N.

Clause 39. The method according to any preceding Clause, wherein the two-dimensional material is, or the stack comprises one or more layers of, graphane, graphene, graphene oxide, or reduced graphene oxide.

Clause 40. The method according to any preceding Clauses, wherein the liquid precursor composition comprises a mixture of a hydrogen donor and a halogen donor, wherein the hydrogen donor selected is from: LiAlH₄, NaBH₄, PH₄I, NH₄Cl, (Me)₃CNH₂, NH₃BH₃, (Me)₃NBH₃, and (Me)₄NBH₄; and wherein the halogen donor selected from: Me₂S·BCl₃, BCl₃, PCl₃, POCl₃, PCl₅, AsCl₃, SbCl₃, and BiCl₃.

Clause 41. The method according to Clause 40, wherein the mixture is formed in situ on the surface of the liquid metal.

Clause 42. The method according to any preceding Clause, wherein the liquid precursor composition comprises polynucleotides, and the reaction comprises cross-linking the polynucleotides.

Clause 42A. The method according to any preceding Clause, wherein the liquid precursor composition is free of solids.

Clause 42B. The method according to any preceding Clause, wherein the liquid precursor composition is free of graphite.

Clause 42C. The method according to any preceding Clause, which is performed at a pressure in the range 0.9 atm to 1.1 atm, optionally about 1 atm.

Clause 43. A method of manufacturing a device, comprising:
synthesising a layer or stack of two-dimensional material using the method of any preceding Clause;
assembling a device comprising the layer or stack.

Clause 44. The method according to Clause 43, wherein the device is selected from: one or more electrodes, a composite wire, a capacitor, a battery, a sensor, a display, a photovoltaic device, an optical fibre, and a nuclear spintronic computer.

Clause 44A. The method according to Clause 44, wherein the device is a nuclear spintronic computer and includes a metal or metal ion selected from beryllium, sodium, aluminium, scandium, manganese, cobalt, yttrium, niobium, rhodium, caesium, praseodymium, terbium, holmium, thulium, gold, bismuth and thorium.

Clause 44B. The method according to Clause 43, wherein the device is a thin-film transistor.

Clause 44C. The method according to Clause 43, wherein the device is an energy storage device comprising an anode, a cathode, and a dielectric arranged between the anode and the cathode.

Clause 45. The method according to any of Clauses 44 to 44B, wherein the device includes:
an anode comprising a material synthesized by a method according to any of Clauses 1 to 42;
a cathode comprising a material synthesized by a method according to any of Clauses 1 to 42.

Clause 46. The method according to any of Clauses 43 to 45, wherein the device includes a sheet of a dielectric material, optionally a sheet of dielectric material synthesized by a method according to any of Clauses 1 to 42.

Clause 46A. The method according to any preceding Clause, further comprising winding the layer or stack to form a fibre.

Clause 46B. The method according to Clause 46A, wherein forming the fibre comprises:
drawing the layer or stack from the surface of the liquid metal along a drawing axis; and
during the drawing, rotating the layer or stack about the drawing axis to form the fibre.

Clause 46C. The method according to Clause 46A or Clause 46B, comprising winding a first layer or stack to form a first fibre; winding a second layer or stack of two-dimensional material to form a second fibre; and spinning the first and second fibres to form a thread.

Clause 46D. The method according to Clause 46C, wherein the first fibre comprises graphene, and wherein the second fibre comprises boron nitride.

Clause 46E. The method according to any of Clauses 43 to 46D, comprising assembling a composite cable comprising two or more different two-dimensional materials.

Clause 46F. The method according to Clause 46E, wherein assembling the composite cable comprises:
spinning or winding a first layer or stack of two-dimensional material to form a core; and
wrapping a further layer or stack of two-dimensional material around the core.

Clause 46G. The method according to Clause 46E or Clause 46F, wherein the composite cable comprises a graphene core and a graphene oxide layer arranged around the graphene core.

Clause 47. Use of a liquid metal as a substrate for the synthesis of a two-dimensional material, the liquid metal having a bulk temperature of less than or equal to 250° C. during the synthesis.

Clause 48. Use according to Clause 47, wherein reagents for the synthesis are arranged in the form of a continuous layer on the surface of the liquid metal, the continuous layer having a thickness in the range 1 to about 10 monolayers.

Clause 49. An apparatus for synthesizing a two-dimensional material, which apparatus comprises:
a bath for containing a liquid metal, a liquid metal being a metal or metal alloy having
a melting point of less than or equal to 250° C. at a pressure of 1 atm;
a movable barrier arranged in the bath and configured for compressing a horizontal film on a flat surface of the liquid metal;
a dipping device arranged over the bath;
   wherein the dipping device comprises:
a mounting for holding a rigid plate in an orientation in which a bottom edge of the rigid plate faces a base of the bath;
an actuator for lowering the rigid plate into the bath and for raising the rigid plate from the bath; and
an actuator for changing a yaw of the rigid plate;
optionally wherein the bath includes a well for receiving at least part of the rigid plate.

Clause 50. The apparatus according to Clause 49, wherein the mounting holds a rigid plate, the rigid plate comprising two sheets of organic polymer arranged in a sandwich structure.

Clause 51. The apparatus according to Clause 49 or Clause 50, wherein the mounting holds the rigid plate, and wherein the bottom edge of the rigid plate is curved.

Clause 52. The apparatus according to any of Clauses 49 to 51, further comprising an ultrasonic generator for sonicating a layer on a surface of the liquid metal.

Clause 53. The apparatus according to any of Clauses 49 to 42, further comprising a dispensing mechanism configured to dispense a composition onto a surface of the liquid metal.

Clause 54. The apparatus according to Clause 53, wherein the dispensing mechanism is movable with respect to the bath.

Clause 55. The apparatus according to any of Clauses 49 to 54, further comprising a voltage source for applying an electric field to a surface of the liquid metal.

Clause 56. The apparatus according to Clause 55, wherein the voltage source is configured to supply a direct current.

Clause 57. The apparatus according to any of Clauses 49 to 56, further comprising one or more sensors for measuring a voltage or electrical current through the liquid metal.

Clause 58. The apparatus according to Clauses 49 to 57, further comprising a pumping system configured to recirculate the liquid metal.

Clause 59. The apparatus according to any of Clauses 49 to 58, further comprising a surface heater for heating a surface of the liquid metal, the surface heater being arranged over the bath.

Clause 60. The apparatus according to any of Clauses 49 to 59, further comprising one or more light sources for irradiating a surface of the liquid metal.

Clause 61. The apparatus according to Clause 60, wherein the one or more light sources comprise one or more infrared light sources.

Clause 62. The apparatus according to Clause 61, wherein the one or more infrared light sources comprise one or more flash infrared light sources.

Clause 63. The apparatus according to any of Clauses 60 to 62, further comprising a detector for detecting light reflected from the surface of the liquid metal.

Clause 64. The apparatus according to any of Clauses 49 to 63, further comprising a suction device for removing a layer or stack of layers of two-dimensional material from a surface of the liquid metal.

Clause 65. The apparatus according to any of Clauses 43 to 55 or 56 to 64, further comprising a movable bar.

Clause 66. The apparatus according to Clause 65, wherein the movable bar is rotatable to wind the sheet of two-dimensional material.

Clause 67. The apparatus according to Clause 65 or Clause 66, wherein the movable bar is configured to fold the two-dimensional material.

Clause 68. The apparatus according to any of Clauses 49 to 67, further comprising a chamber enclosing the bath.

Clause 69. The apparatus according to Clause 68, further comprising a gas supply connected to the chamber.

Clause 70. A system comprising the apparatus according to any of Clauses 49 to 69 and a control module communicatively connected to the apparatus, the control module comprising a processor and a memory storing instructions executable by the processor, and being configured to control operation of one or more components of the apparatus.

Clause 71. A computer program product comprising instructions which, when executed by a processor of a system as defined in Clause 70, cause the system to perform a method according to any of Clauses 1 to 46C.

Clause 72. An energy storage device, comprising:
an anode;
a cathode; and
a dielectric arranged between the anode and the cathode,
wherein one or more of the anode, the cathode, and the dielectric comprises a layer of two-dimensional material or stack of layers of two-dimensional material.

Clause 72A. The energy storage device of Clause 72, wherein one or more of the anode, the cathode, and the dielectric comprises a layer of two-dimensional material or stack of layers of two-dimensional material obtainable by the method according to any of Clauses 1 to 46C.

Clause 72B. The energy storage device of Clause 72 or Clause 72A, wherein the anode and the cathode each comprise a layer of two-dimensional material or stack of layers of two-dimensional material.

Clause 72C. The energy storage device of any of Clauses 72 to 72B, wherein the dielectric comprises a layer of two-dimensional material or stack of layers of two-dimensional material.

Clause 73. The energy storage device according to any of Clauses 72 to 72C, wherein at least one of the anode and the cathode comprises a composite stack, the composite stack comprising two polymers forming a redox pair.

Clause 74. The energy storage device according to Clause 73, wherein the anode and cathode both comprise composite stacks, the composite stacks comprising different respective redox pairs of polymers.

Clause 75. The energy storage device according to any of Clauses 72 to 74, wherein the anode comprises one or more two-dimensional layers of a conductive polymer comprising units of formula:

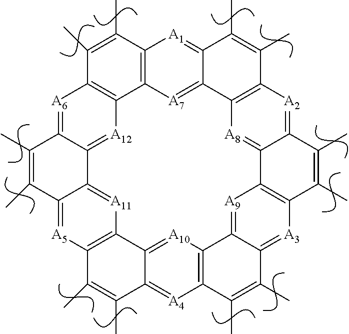

wherein A1 to A12 are each individually selected from N and N⁺—R, where R is a C₁ to C₃ alkyl group, preferably methyl.

Clause 76. The energy storage device according to any of Clauses 72 to 74, wherein the anode comprises one or more two-dimensional layers of a conductive polymer comprising units of formula:

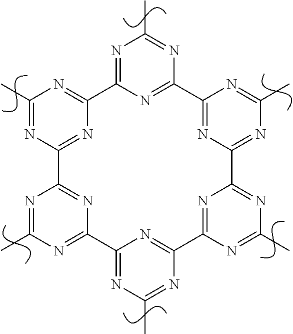

Clause 77. The energy storage device of any of Clauses 72 to 76, wherein the dielectric comprises a layer or stack of layers of a material selected from boron nitride and perfluorinated graphane, or another material.

Clause 78. The energy storage device of any of Clauses 72 to 77, wherein the cathode comprises a layer or stack of layers of a conductive polymer comprising units of formula:

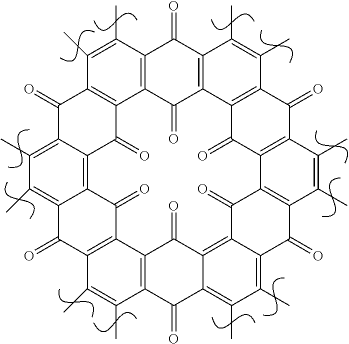

Clause 79. The energy storage device of any of Clauses 72 to 78, wherein the cathode comprises a layer or stack of layers of a cross-linked polymer comprising chains of formula:

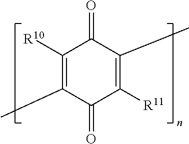

where R10 and R11 are each independently selected from H, a halogen such as F, CN, and O—R, where R represents a C1 to C3 alkyl group.

Clause 80. The energy storage device according to any of Clauses 72 to 79, wherein the anode, cathode and dielectric are free of metals, e.g. metal ions.

Clause 79A. The energy storage device according to any of Clauses 72 to 79, which is free of any electrolyte.

Clause 80A. A method of manufacturing an energy storage device, which method comprises:
synthesizing a first layer of two-dimensional material or stack of layers of two-dimensional material by:
   providing a first liquid precursor composition on a flat surface of a liquid metal, the liquid metal being a metal or metal alloy having a melting point of less than or equal to 250° C. at a pressure of 1 atm; and
   forming the first layer or stack on the surface of the liquid metal from the first liquid precursor composition;
synthesizing a second layer of two-dimensional material or stack of layers of two dimensional material by:
   providing a second liquid precursor composition over the flat surface of the liquid metal and over the first layer or stack; and
   forming the second layer or stack on the surface of the liquid metal from the second liquid precursor composition;
synthesizing a third layer of two-dimensional material or stack of layers or two-dimensional material by:
   providing a third liquid precursor composition over the flat surface of the liquid metal and over the third layer or stack; and
   forming the third layer or stack on the surface of the liquid metal from the third liquid precursor composition;
      wherein the first layer is one of an anode and a cathode; the third layer is the other of an anode and a cathode; and the second layer is a dielectric.

Clause 80B. The method according to Clause 80A, wherein:
synthesizing the first layer comprises performing a method of any of Clauses 1 to 42C; and/or
synthesizing the second layer comprises performing a method of any of Clauses 1 to 42C; and/or
synthesizing the third layer comprises performing a method of any of Clauses 1 to 42C.

Clause 81. A method of synthesizing a layer of a material or a stack of layers of material, which method comprises:
providing a liquid precursor composition on a flat surface of a liquid metal, the liquid metal being a metal or metal alloy having a melting point of less than or equal to 250° C. at a pressure of 1 atm; and
forming at least one layer of material on the surface of the liquid metal from the liquid precursor composition.

Clause 82. A composite cable obtainable by the method of any of Clauses 46C to 46G.

Clause 83. A thread, rope, or fabric comprising a fibre obtainable by the method of Clause 46A or Clause 46B.

Clause 84. A wearable device, comprising the fabric according to Clause 83.

Clause 85. A composite cable, comprising:
a core, the core comprising a fibre spun from a layer of two-dimensional material or a stack of layers of two-dimensional material; and
at least one further layer of two-dimensional material or stack of layers of two-dimensional material, the at least one further layer surrounding the core;
wherein the core and the at least one further layer comprise different materials.

Clause 86. The composite cable according to claim 85, which is configured as a fibre optic cable, the core and the at least one further layer having different refractive indices.

Clause 87. The composite cable according to claim 85 or claim 86, which includes an electrically-conductive two-dimensional material.

Clause 88. The composite cable according to any of Clauses 85 to 87, wherein the core comprises graphene and the at least one further layer comprises a graphene oxide layer.

Other variants and areas of applicability of the disclosed techniques may become apparent to the person skilled in the art once given the disclosure herein. The scope of the disclosure is not limited by the described embodiments but only by the accompanying claims.

1-19. (canceled)

20. An energy storage device, comprising:
an anode comprising a layer of two-dimensional material or a stack of layers of two-dimensional material;
a cathode comprising a layer of two-dimensional material or a stack of layers of two-dimensional material; and
a dielectric arranged between the anode and the cathode;
wherein the anode, cathode and dielectric are free of metal atoms and metal ions.

21. (canceled)

22. The energy storage device according to claim 20, wherein:
the anode comprises a composite stack comprising two two-dimensional polymers, the two two-dimensional polymers being a first redox pair; and
the cathode comprises a composite stack comprising two two-dimensional polymers, the two two-dimensional polymers being a second redox pair different from the first redox pair.

23. The energy storage device according to claim 20, wherein the anode comprises one or more two-dimensional layers of a conductive polymer comprising units of formula: 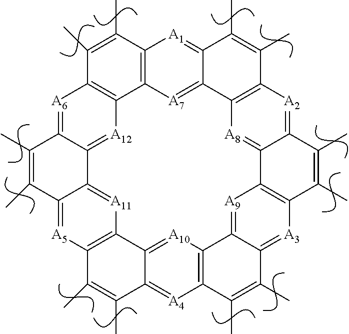
wherein A1 to A12 are each individually selected from N and N⁺—R, where R is a C1 to C3 alkyl group.

24. The energy storage device according to claim 20, wherein the anode comprises one or more two-dimensional layers of a conductive polymer comprising units of formula:

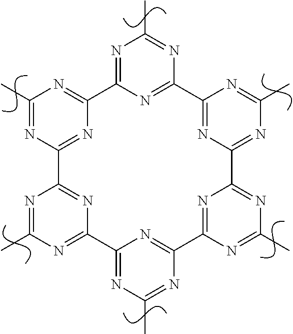

25. The energy storage device of claim 20, wherein the dielectric comprises a layer or stack of layers of a material selected from boron nitride and perfluorinated graphane.

26. The energy storage device of claim 20, wherein the cathode comprises a layer or stack of layers of a conductive polymer comprising units of formula:

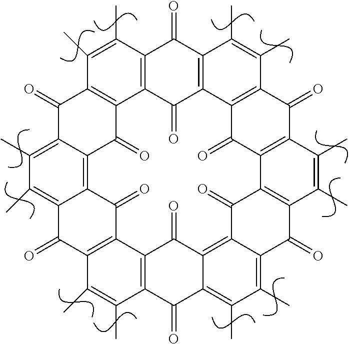

27. The energy storage device of claim 20, wherein the cathode comprises a layer or stack of layers of a cross-linked polymer comprising chains of formula: 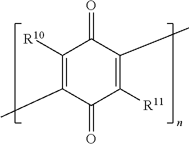
where R₁₀ and R₁₁ are each independently selected from H, a halogen, CN, and O—R, where R represents a C₁ to C₃ alkyl group.

28. (canceled)

29. A method of manufacturing the energy storage device of claim 20, which method comprises synthesizing the anode, synthesizing the cathode, and assembling the energy storage device, wherein synthesizing the anode and synthesizing the cathode comprises:
providing a liquid precursor composition on a flat surface of a liquid metal, the liquid metal being a metal or metal alloy having a melting point of less than or equal to 250° C. at a pressure of 1 atm; and
forming a respective one of the anode and the cathode on the surface of the liquid metal from the liquid precursor composition.

30. (canceled)

31. The energy storage device of claim 20, which is free of an electrolyte solution and which is free of a solid electrolyte.

32. The method according to claim 29, wherein the liquid metal is mercury or Wood's metal.

33. The method according to claim 29, which method comprises:
synthesizing a first layer of two-dimensional material or stack of layers of two-dimensional material by:
providing a first liquid precursor composition on a flat surface of a liquid metal, the liquid metal being a metal or metal alloy having a melting point of less than or equal to 250° C. at a pressure of 1 atm; and
forming the first layer or stack on the surface of the liquid metal from the first liquid precursor composition;
synthesizing a second layer of two-dimensional material or stack of layers of two dimensional material by:
providing a second liquid precursor composition over the flat surface of the liquid metal and over the first layer or stack; and
forming the second layer or stack on the surface of the liquid metal from the second liquid precursor composition;
synthesizing a third layer of two-dimensional material or stack of layers or two-dimensional material by:
providing a third liquid precursor composition over the flat surface of the liquid metal and over the third layer or stack; and
forming the third layer or stack on the surface of the liquid metal from the third liquid precursor composition;
wherein the first layer is one of an anode and a cathode; the third layer is the other of an anode and a cathode; and the second layer is a dielectric.

34. The method according to claim 29, further comprising using a movable barrier to form and/or compress a thin layer of the liquid precursor composition, the thin layer having a thickness in the range 1 to 10 monolayers.

35. The method according to claim 29, wherein forming the anode or cathode on the surface of the liquid metal comprises performing a reaction of the liquid metal precursor composition.

36. The method according to claim 35, wherein the reaction comprises an electrochemical process, the electrochemical process including passing a current through the liquid precursor composition.

37. The method according to claim 29, further comprising conditioning the anode or cathode on the surface of the liquid metal.

38. The method according to claim 37, wherein the conditioning comprises annealing and/or sonicating the anode or cathode.

39. The method according to claim 29, wherein synthesizing the anode or synthesizing the cathode comprises synthesizing a stack comprising at least two layers of two-dimensional material, the stack being a composite stack comprising layers of two or more different two-dimensional materials.

40. The method according to claim 29, further comprising transferring the anode or cathode onto a dipping plate.

41. The method according to claim 40, comprising:
performing a first synthesis to form at least one first layer of two-dimensional material on the surface of the liquid metal;
transferring the at least one first layer onto a dipping plate;
performing a second synthesis to form at least one further layer of two-dimensional material on the surface of the liquid metal; and
transferring the at least one further layer onto the at least one first layer, thereby forming a stack.

42. The method according to claim 41, wherein the method further comprises:
after transferring the at least one first layer and before transferring the at least one second layer, changing a yaw of the dipping plate.
